(19) United States
(12) Patent Application Publication
(10) Pub. No.: US 2025/0116947 A1
(43) Pub. Date: Apr. 10, 2025

(54) TONER

(71) Applicant: CANON KABUSHIKI KAISHA, Tokyo (JP)

(72) Inventors: HITOSHI SANO, Chiba (JP); ICHIRO KANNO, Chiba (JP); TORU TAKAHASHI, Ibaraki (JP); RYUICHIRO MATSUO, Ibaraki (JP); MARI KABURAGI, Chiba (JP); HAYATO IDA, Ibaraki (JP); YUYA CHIMOTO, Chiba (JP)

(21) Appl. No.: 18/907,332

(22) Filed: Oct. 4, 2024

(30) Foreign Application Priority Data
Oct. 6, 2023 (JP) 2023-174001

(51) Int. Cl. G03G 9/093

(52) U.S. Cl. CPC G03G 9/09328; G03G 9/09342

(57) ABSTRACT

A toner includes toner particles each containing a binder resin and a release agent, and composite particles each present on a surface of each toner particle. The release agent has a penetration of 4 or less at 25° C. The composite particles include fine particles A each containing an organosilicon compound having a siloxane bond, the organosilicon compound serving as a binder component, and fine particles B formed of inorganic fine particles. Each fine particle B is partially embedded at the surface of each fine particle A. In the fine particles A, the proportions of di- to tetra-functional silicon atoms satisfy predetermined requirements. The fine particles B have a number-average diameter of primary particles of 0.01 μm or more and 0.06 μm or less. In the composite particles, the average value of embedding ratios of the fine particles B to the fine particles A is 30% or more and 90% or less.

### BACKGROUND

### Field

The present disclosure relates to a toner used in an electrophotographic system, an electrostatic recording system, an electrostatic printing system, and a toner jet system.

### Description of the Related Art

In recent years, as full-color electrophotographic copiers have come into widespread use, there has been an increasing demand for toners used in electrophotography to meet the increasing demands for higher-speed printing in the print-on-demand (POD) field and to have longer life.

Hitherto, spherical silica and so forth have been widely used as external additives for toners. The use of irregularly shaped external additives has also been known to improve the cleaning performance of and inhibit a deterioration in the durability of photoconductors.

For example, Japanese Patent No. 5982003 discloses an example in which fine particles produced by adding silica to a vinyl monomer and combining them together are added to toner base particles to improve the flowability of the toner.

In Examples of Japanese Patent No. 5982003, there is no description of an example in which a toner containing the fine particles was subjected to an image forming test with a copier. However, in the case of a toner to which the fine particles, which are a composite of silica added to a vinyl monomer as described in Japanese Patent No. 5982003, are externally added, the fine particles may be detached from a medium due to stress from a conveying roller to the medium in the copier as the speed of a copier increases. The toner may transfer from the medium to the conveying roller, and then the transferred toner may cause the soiling of an end portion (hereinafter, also referred to as “end portion soiling”) of the medium conveyed through the copier.

### SUMMARY

The present disclosure provides a toner that has high low-temperature fixability and charging stability required in the POD field and that does not cause the end portion soiling.

One disclosed aspect of the present disclosure is directed to providing a toner including toner particles each containing a binder resin and a release agent, and composite particles each present on a surface of each of the toner particles. The release agent has a penetration of 4 or less at 25° C. The composite particles include fine particles A each containing an organosilicon compound having a siloxane bond, the organosilicon compound serving as a binder component, and fine particles B formed of inorganic fine particles. Each of the fine particles B is partially embedded at the surface of each of the fine particles A. The following expressions (1) to (3) are satisfied:

$$Pa + Pb + Pc \geq 0.8 \qquad ( 1 )$$

$$Pb + Pc \geq 0.3 \qquad ( 2 )$$

$$Pa / ( Pa + Pb + Pc ) \leq 0.7 \qquad ( 3 )$$

where in the fine particles A, based on total silicon atoms contained in the organosilicon compound, Pa is the proportion of silicon atoms denoted by Si^{a} in a structure represented by the following unit (a), Pb is the proportion of silicon atoms denoted by Si^{b} in a structure represented by the following unit (b), and Pc is the proportion of silicon atoms denoted by Si^{c} in a structure represented by the following unit (c):

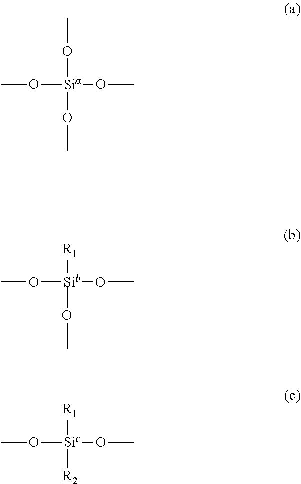

where R₁ and R₂ are each an alkyl group having 1 or more and 6 or less carbon atoms. The fine particles B have a number-average diameter of primary particles of 0.01 μm or more and 0.06 μm or less. In the composite particles, the average value of embedding ratios of the fine particles B to the fine particles A is 30% or more and 90% or less, each of the embedding ratios being represented by the following expression:

Each embedding ratio of each fine particle B to each fine particle A (%)=(the depth of each fine particle B embedded in each fine particle A/the diameter of each fine particle B)×100.

Further features of the present disclosure will become apparent from the following description of exemplary embodiments.

### DESCRIPTION OF THE EMBODIMENTS

In an embodiment of the present disclosure, each of the expressions “XX or more and YY or less” and “XX to YY” refers to a numerical range that includes the lower limit and the upper limit, which are end points, unless otherwise specified. A toner according to an embodiment of the present disclosure includes toner particles and an external additive for toner. In the following description, the “toner particles” may be referred to as “toner base particles”.

### Features of Present Disclosure

The inventors believe that the mechanism by which the effects of an embodiment of the present disclosure are manifested is as described below.

Hitherto, composite particles that have been used as external additives for toner have excellent adhesion to toner base particles. However, in a toner layer that has been fixed on a medium, the adhesion of the composite particles may be insufficient. As an external force from a conveying roller increases due to an increase in the speed of a copier, there is room for improvement from the viewpoint that the toner may be detached from the medium to cause the end portion soiling.

The inventors have conducted intensive studies and have found that a toner according to an embodiment of the present disclosure can solve the above problems by combining composite particles according to an embodiment of the present disclosure with a release agent having a low penetration. The finding has led to the completion of the present disclosure. Although the mechanism is not clear, the inventors speculate that by fixing a toner containing the release agent having a low penetration and the composite particles according to an embodiment of the present disclosure, the release agent exudes to the surface layer of the fixed image to cover the surface of the fixed image with the release agent, leading to the composite particles partially buried in the release agent. This results in a large contact area between the composite particles and the release agent on the surface of the fixed image.

When the release agent fixing the composite particles has a certain hardness, the composite particles on the fixed image can be inhibited from coming off due to an external force.

The composite particles have an irregular surface shape. Thus, the area of contact with the outside is smaller than that of external additive particles having the same primary particle diameter, thereby enabling the reduction of the effect of the external force. Furthermore, when the composition of the binder of the composite particles is controlled within the range according to an embodiment of the present disclosure, the binder portion of the composite particles can reduce an external force applied to the composite particles.

The inventors speculate that the combination of the release agent having a low penetration and the composite particles according to an embodiment of the present disclosure inhibits the detachment of the toner from the medium to inhibit the occurrence of the end portion soiling.

### Composite Particles According to Embodiment of Present Disclosure

The configuration of composite particles according to an embodiment of the present disclosure and a method for producing the composite particles will be described in detail below.

The composite particles according to an embodiment of the present disclosure include fine particles A each containing an organosilicon compound having a siloxane bond, the organosilicon compound serving as a binder component, and fine particles B formed of inorganic fine particles.

Each of the fine particles B is partially embedded at the surface of each of the fine particles A.

The following expressions (1) to (3) are satisfied:

$$Pa + Pb + Pc \geq 0.8 \qquad ( 1 )$$

$$Pb + Pc \geq 0.3 \qquad ( 2 )$$

$$Pa / ( Pa + Pb + Pc ) \leq 0.7 \qquad ( 3 )$$

where in the fine particles A, based on total silicon atoms contained in the organosilicon compound, Pa is the proportion of silicon atoms denoted by Si^{a} in a structure represented by the following unit (a), Pb is the proportion of silicon atoms denoted by Si^{b} in a structure represented by the following unit (b), and Pc is the proportion of silicon atoms denoted by Si^{c} in a structure represented by the following unit (c):

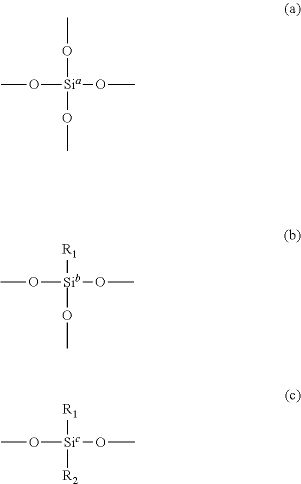

where R₁ and R₂ are each an alkyl group having 1 or more and 6 or less carbon atoms.

The fine particles B have a number-average diameter of primary particles of 0.01 μm or more and 0.06 μm or less. The average value of embedding ratios of the fine particles B to the fine particles A is 30% or more and 90% or less, each of the embedding ratios being represented by the following expression:

Each embedding ratio of each fine particle B to each fine particle A (%)=(the depth of each fine particle B embedded in each fine particle A/the diameter of each fine particle B)×100.

The composite particles used in an embodiment of the present disclosure can have a number-average diameter of primary particles of 0.03 μm or more and 0.30 μm or less. When the number-average diameter of the primary particles is within the above range, a fixed image can be uniformly covered with the external additive of the fine particles. This can reduce stress on the fixed image to easily provide the effect of inhibiting the end portion soiling.

The number-average diameter of the primary particles of the composite particles can be increased by reducing the reaction temperature, reducing the reaction time, and increasing the amount of catalyst in the hydrolysis and condensation step. The number-average diameter of the primary particles of the composite particles can be reduced by increasing the reaction temperature, increasing the reaction time, and reducing the amount of catalyst in the hydrolysis and condensation step.

The number-average diameter of the primary particles of the composite particles is preferably 0.07 μm or more and 0.20 μm or less, more preferably 0.08 μm or more and 0.15 μm or less, from the above viewpoint.

The composite particles used in an embodiment of the present disclosure can have a Young's modulus of 10 GPa or more and 30 GPa or less. At a Young's modulus within the above range, when a fixed image is subjected to stress from a member, such as a conveying roller, the stress can be relieved to further inhibit the detachment of the external additive from the fixed image.

At a Young's modulus of more than 10 GPa, the external additive itself is less likely to be damaged when a fixed image is subjected to stress from a member, such as a conveying roller. At a Young's modulus of less than 30 GPa, when a fixed image is subjected to stress from a member, such as a conveying roller, the stress can be easily relieved to further inhibit the detachment of the external additive from the surface of the fixed image. The composite particles can have a Young's modulus of 13 GPa or more and 20 GPa or less from the viewpoint of inhibiting the end portion soiling.

The Young's modulus of the composite particles used in an embodiment of the present disclosure can be controlled by changing the mixing ratio of the alkoxysilanes having the above structures (a) to (c), and the temperature, time, pH, and type of catalyst in the hydrolysis and condensation step. Examples of a method for increasing the Young's modulus include an increase in the mixing proportion of an alkoxysilane having the structure (a), decreases in the mixing proportions of alkoxysilanes having the structures (b) and (c), an increase in the temperature of the hydrolysis and condensation step, an increase in the time of the hydrolysis and condensation step, and an increase in pH during the hydrolysis and condensation step. Examples of a method for decreasing the Young's modulus include a decrease in the mixing proportion of an alkoxysilane having the structure (a), increases in the mixing proportions of alkoxysilanes having the structures (b) and (c), a decrease in the temperature of the hydrolysis and condensation step, a decrease in the time of the hydrolysis and condensation step, and a decrease in pH during the hydrolysis and condensation step.

With regard to the organosilicon compound having a siloxane bond in the fine particles A of the composite particles used in an embodiment of the present disclosure, the following expressions (1) to (3) are satisfied:

$$Pa + Pb + Pc \geq 0.8 \qquad ( 1 )$$

$$Pb + Pc \geq 0.3 \qquad ( 2 )$$

$$Pa / ( Pa + Pb + Pc ) \leq 0.7 \qquad ( 3 )$$

where Pa is the proportion of silicon atoms denoted by Si^{a} in the structure represented by the above unit (a), Pb is the proportion of silicon atoms denoted by Si^{b} in the structure represented by the above unit (b), and Pc is the proportion of silicon atoms denoted by Si^{c} in the structure represented by the above unit (c).

Within the above ranges, the composite particles, which are the external additive, are not easily damaged when a fixed image is subjected to stress from a conveying roller or the like. In addition, appropriate flexibility of the external additive results in inhibition of detachment of the external additive from the surface of the fixed image. Thus, the state of the surface of the fixed image is less likely to change, inhibiting the occurrence of the end portion soiling. The proportions of the amounts of units (a), (b), and (c) described above in the composite particles can be controlled by the amounts of alkoxysilanes having the structures added.

The fine particles B of the composite particles used in an embodiment of the present disclosure can be inorganic fine particles having a Young's modulus of 50 GPa or more and 200 GPa or less. At a Young's modulus within the above range, when a fixed image is subjected to stress from a member, such as a conveying roller, the external additive itself is less likely to be damaged, thereby inhibiting the occurrence of the end portion soiling.

At least a portion of each fine particle B is embedded at the surface of each fine particle A. The average value of the embedding ratio is 30% or more and 90% or less. In the case where the average value of the embedding ratio is within the above range, the fine particles B are less likely to be detached when a fixed image is subjected to stress from a member, such as a conveying roller, thereby inhibiting the occurrence of the end portion soiling. The embedding ratio of the fine particles B can be controlled by the reaction time and reaction temperature with the alkoxysilanes having the structures (a) to (c) above. Examples of a method for reducing the embedding ratio include a method in which the reaction time of the reaction between the alkoxysilanes and the fine particles B is reduced; and a method in which the reaction temperature is reduced. Examples of a method for increasing the embedding ratio include a method in which the reaction time of the reaction between the alkoxysilanes and the fine particles B is increased; and a method in which the reaction temperature is increased.

When fine particles containing an organosilicon compound having a siloxane bond as a binder component, the fine particles being free of protrusions derived from the inorganic fine particles B, are used as an external additive in a toner, a desired anchor effect derived from the protrusions cannot be provided, thereby failing to firmly fix the fine particles to the release agent. Fine particles in which inorganic fine particles B are completely embedded inside fine particles containing an organosilicon compound as a binder component are considered to have no protrusions. Such fine particles cannot be firmly fixed to the release agent for the same reason. When non-spherical inorganic fine particles composed of, for example, silica are used in a toner, they can be fixed onto a fixed image depending on the shape. However, when a fixed image is subjected to stress from a member, such as a conveying roller, the stress cannot be relieved, thereby failing to inhibit detachment from the fixed image.

Methods for measuring the various physical property values described above will be described below.

### Production Method

A method for producing the composite particles used in an embodiment of the present disclosure is not limited to a particular method, but the particles can be formed by a sol-gel method through hydrolysis and a polycondensation reaction of a silicon compound (silane monomer). Specifically, a mixture of a difunctional silane having two siloxane bonds and a tetrafunctional silane having four siloxane bonds is subjected to hydrolysis and polycondensation, and then allowed to react with colloidal silica or the like, resulting in the formation of composite particles. Silane monomers, such as difunctional silanes and tetrafunctional silanes, will be described below. The proportion of the difunctional silane is preferably 30% by mole or more and 70% by mole or less, more preferably 40% by mole or more and 60% by mole or less. The proportion of the tetrafunctional silane is preferably 30% by mole or more and 70% by mole or less, more preferably 40% by mole or more and 70% by mole or less.

The composite particles used in an embodiment of the present disclosure include, as a main portion, particles (fine particles A) composed of an organosilicon compound having a siloxane bond as a binder.

A method for producing a silicon compound according to an embodiment of the present disclosure is not limited to a particular method. For example, a silane compound can be added dropwise to water to perform hydrolysis and a condensation reaction in the presence of a catalyst, and then the resulting suspension can be filtered and dried to give a silicon compound. The particle size can be controlled by the type of catalyst, the mixing ratio, the reaction initiation temperature, the dropwise addition time, and so forth. Non-limiting examples of the catalyst include acidic catalysts, such as hydrochloric acid, hydrofluoric acid, sulfuric acid, and nitric acid; and basic catalysts, such as aqueous ammonia, sodium hydroxide, and potassium hydroxide.

The silicon compound according to an embodiment of the present disclosure can be produced by the following method. Specifically, the method can include a first step of preparing a hydrolysate of a silicon compound, a second step of mixing the hydrolysate with an aqueous alkaline medium and colloidal silica to cause a polycondensation reaction of the hydrolysate with the colloidal silica, and a third step of mixing the polycondensate with an aqueous solution to form particles. In some cases, a hydrophobizing agent may also be added.

In the first step, in an aqueous solution in which an acidic or alkaline substance acting as a catalyst is dissolved in water, the silicon compound are brought into contact with the catalyst by stirring, mixing, or the like. As the catalyst, a known catalyst can be used. Specific examples of the catalyst include acidic catalysts, such as acetic acid, hydrochloric acid, hydrofluoric acid, sulfuric acid, and nitric acid; and basic catalysts, such as aqueous ammonia, sodium hydroxide, and potassium hydroxide.

The amount of the catalyst used may be appropriately adjusted in accordance with the types of silicon compound and catalyst. The amount of the catalyst used is selected from the range of 1×10⁻³ parts by mass or more and 1 part by mass or less based on 100 parts by mass of water used in the hydrolysis of the silicon compound.

When the amount of the catalyst used is 1×10⁻³ parts by mass or more, the reaction proceeds sufficiently. When the amount of the catalyst used is 1 part by mass or less, the concentration of the catalyst remaining as an impurity in the fine particles is low, and the catalyst is easily hydrolyzed. The amount of water used can be 2 mol or more and 15 mol or less per mole of the silicon compound. When the amount of water is 2 mol or more, the hydrolysis reaction proceeds sufficiently. When the amount of water is 15 mol or less, the productivity is improved.

The reaction temperature is not limited to a particular value. The reaction may be carried out at room temperature or under heating. The reaction can be carried out at a temperature maintained at 10° C. to 60° C. because a hydrolysate can be given in a short period of time and because a partial condensation reaction of the resulting hydrolysate can be inhibited. The reaction time is not limited to a particular value, and may be appropriately selected in consideration of the reactivity of the silicon compound used, the composition of the reaction liquid prepared by mixing the silicon compound, acid, and water, and productivity.

In the second step of the method for producing a silicon compound, the raw material solution prepared in the first step is mixed with an aqueous alkaline medium, so that the particle precursor is subjected to a polycondensation reaction. This results in a polycondensation reaction liquid. The aqueous alkaline medium is a liquid prepared by mixing an alkaline component, water, and, if necessary, an organic solvent or the like.

The alkaline component used in the aqueous alkaline medium is an alkaline component whose aqueous solution is basic and acts as a neutralizing agent for the catalyst used in the first step and as a catalyst for the polycondensation reaction in the second step. Examples of the alkaline component include alkali metal hydroxides, such as lithium hydroxide, sodium hydroxide, and potassium hydroxide; ammonia; and organic amines, such as monomethylamine and dimethylamine.

The amount of the alkaline component used is an amount that neutralizes the acid and effectively acts as a catalyst for the polycondensation reaction. For example, when ammonia is used as the alkaline component, the amount of the alkaline component used is usually selected from 0.01 parts by mass or more and 12.5 parts by mass or less based on 100 parts by mass of the mixture of water and the organic solvent.

In the second step, in order to prepare an aqueous alkaline medium, an organic solvent may be further used in addition to the alkaline component and water. Any organic solvent may be used as long as it is compatible with water. An organic solvent that dissolves at least 10 g of water per 100 g at room temperature and normal pressure can be used.

Specific examples thereof include alcohols, such as methanol, ethanol, n-propanol, 2-propanol, and butanol; polyhydric alcohols, such as ethylene glycol, diethylene glycol, propylene glycol, glycerol, trimethylolpropane, and hexanetriol; ethers, such as ethylene glycol monoethyl ether, acetone, diethyl ether, tetrahydrofuran, and diacetone alcohol; amide compounds, such as dimethylformamide, dimethylacetamide, and N-methylpyrrolidone.

Among the organic solvents listed above, alcohol solvents, such as methanol, ethanol, 2-propanol, and butanol, can be used. From the viewpoint of hydrolysis and a dehydration condensation reaction, the same alcohol as the alcohol formed by elimination can be selected as the organic solvent.

In the third step, the polycondensate formed in the second step is mixed with the aqueous solution to form particles. The aqueous solution may be water, such as tap water or pure water. A component compatible with water, such as a salt, an acid, an alkali, an organic solvent, a surfactant, or a water-soluble polymer, may be further added to water. The temperature of the polycondensation reaction liquid and the aqueous solution when they are mixed is not limited to particular value, and can be selected in the range of 5° C. to 70° C. in consideration of their compositions, productivity, and so forth.

Any known method for recovering particles can be used. Examples include a method in which a suspended powder is scooped out and a filtration method. The filtration method can be used because of its simple operation. Any filtration method can be used. Any known device, such as a vacuum filtration device, a centrifugal filtration device, or a pressure filtration device, may be selected. Filter paper, a filter, a filter cloth, and so forth used for filtration are not particularly limited as long as they are industrially available, and they may be appropriately selected in accordance with a device to be used.

The monomer to be used can be appropriately selected in accordance with its compatibility with the solvent and catalyst, its hydrolyzability, and the like. Examples of the tetrafunctional silane monomer having the above structure (a) include tetramethoxysilane, tetraethoxysilane, and tetraisocyanatosilane, and among these, tetraethoxysilane can be used.

Examples of the trifunctional silane monomer having the above structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydimethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these, methyltrimethoxysilane can be used.

Examples of the difunctional silane monomer having the above structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. Among them, dimethyldimethoxysilane can be used.

Other Physical Properties of Composite Particles According to Embodiment of Present Disclosure

The true specific gravity of the composite particles used in an embodiment of the present disclosure can be 1.00 g/cm³ or more and 1.60 g/cm³ or less. Within the above range, when the fixed image is subjected to stress from a member, such as a conveying roller, detachment of the external additive from the fixed image and damage to the external additive itself can be inhibited. The true specific gravity of the external additive can be controlled by the amount of the fine particles B added. The true specific gravity of the external additive for toner can be 1.20 g/cm³ or more and 1.40 g/cm³ or less.

In an electron image obtained by photographing sections of the composite particles used in an embodiment of the present disclosure with a transmission electron microscope, letting the area of a section X of one particle of the fine particles A photographed be Sa, and letting the total area of the fine particles B that are entirely contained in the section X and that are present in an unexposed state be Sb, the average value of Sb/Sa for 100 particles of the fine particles A is 0 or more and 0.50 or less. From the viewpoint of inhibiting the end portion soiling, when a fixed image is subjected to stress from a member, such as a conveying roller, the detachment of the external additive from the fixed image can be inhibited. Sb/Sa can be controlled by the amount of the fine particles B added, and the reaction time and reaction temperature of the reaction between the fine particles B and the monomer to be formed into the fine particles A.

In the composite particles used in an embodiment of the present disclosure, letting the number-average diameter of primary particles of the fine particles A be AD, and letting the number-average diameter of the primary particles of the fine particles B be BD, the BD/AD ratio can be 0.05 or more and 0.70 or less. Within the above range, the adhesion of the external additive to the release agent on the surface of a fixed image can be increased from the viewpoint of inhibiting the end portion soiling. The number-average diameter of the primary particles of the fine particles A can be controlled by adjusting the reaction conditions in the hydrolysis and condensation step by the above-mentioned method. The number-average diameter of the primary particles of the fine particles B is controlled by selecting the fine particles to be added.

The fine particles B of the composite particles used in an embodiment of the present disclosure can be fine silica particles or fine alumina particles. When the fine particles B are the above-mentioned fine particles, they have an appropriate hardness, and thus the adhesion to the surface of a fixed image is increased. In this case, the fine particles can be used to inhibit the end portion soiling. From the viewpoint of reactivity with the binder component constituting the fine particles A, fine silica particles can be used. The fine silica particles used in an embodiment of the present disclosure are particles mainly composed of silica (that is, SiO₂) and may be particles produced using a silicon compound, such as water glass or an alkoxysilane, as a raw material, or may be particles produced by grinding quartz.

Specific examples thereof include silica particles produced by a sol-gel method, precipitated silica particles produced by a precipitation method, aqueous colloidal silica particles, fumed silica particles produced by a gas phase method, and fused silica particles. Among these, aqueous colloidal silica particles can be used from the viewpoints of reactivity with the binder component and dispersion stability. The aqueous colloidal silica particles are commercially available or can be prepared by any of known methods from a variety of starting materials. The aqueous colloidal silica particles can be prepared from silicic acid derived from an alkali silicate solution having a pH of about 9 to about 11, where the silicate anions undergo polymerization to produce silica particles having a desired average particle size in the form of an aqueous dispersion.

The composite particles used in an embodiment of the present disclosure can have their surfaces treated with a hydrophobizing agent. The hydrophobizing agent can be, but is not particularly limited to, an organosilicon compound.

Examples thereof include alkylsilazane compounds, such as hexamethyldisilazane; alkylalkoxysilane compounds, such as diethyldiethoxysilane, trimethylmethoxysilane, methyltrimethoxysilane, and butyltrimethoxysilane; fluoroalkylsilane compounds, such as trifluoropropyltrimethoxysilane; chlorosilane compounds, such as diethyldichlorosilane and trimethylchlorosilane; siloxane compounds, such as octamethylcyclotetrasiloxane; and silicone oil and silicone varnish.

Hydrophobization treatment of the composite particles used in an embodiment of the present disclosure enables inhibition of a change in the electrostatic adhesion of the toner after a durability test. Among these, the composite particles used in an embodiment of the present disclosure can be surface-treated with at least one compound selected from the group consisting of alkylsilazane compounds, alkylalkoxysilane compounds, chlorosilane compounds, siloxane compounds, and silicone oils. From the above viewpoint, the composite particles used in an embodiment of the present disclosure can be surface-treated with an alkylsilazane compound.

With regard to the organosilicon compound having a siloxane bond in the fine particles A of the composite particles used in an embodiment of the present disclosure, the following expressions (I) to (III) can be satisfied:

$$0.3 \leq Pa / ( Pa + Pb + Pc ) \leq 0.7 \qquad ( I )$$

$$0 \leq Pb / ( Pa + Pb + Pc ) \leq 0.5 \qquad ( II )$$

$$0.2 \leq Pc / ( Pa + Pb + Pc ) \leq 0.7 \qquad ( III )$$

where Pa is the proportion of silicon atoms denoted by Si^{a} in the structure represented by the above unit (a), Pb is the proportion of silicon atoms denoted by Si^{b} in the structure represented by the above unit (b), and Pc is the proportion of silicon atoms denoted by Si^{c} in the structure represented by the above unit (c).

Within the above range, when a fixed image is subjected to stress from a member, such as a conveying roller, detachment of the external additive from the fixed image and damage to the external additive itself can be inhibited. When the following expressions:

$$0.4 \leq Pa / ( Pa + Pb + Pc ) \leq 0.7 \qquad ( I ' )$$

$$0 \leq Pb / ( Pa + Pb + Pc ) \leq 0.1 \qquad ( II ' )$$

$$0.3 \leq Pc / ( Pa + Pb + Pc ) \leq 0.6 \qquad ( III ' )$$

are satisfied, the amount of Si—CH₃ present in the external additive can be optimized from the viewpoint of inhibiting the end portion soiling.

The amount of the composite particles used in an embodiment of the present disclosure is preferably 0.1 parts by mass or more and 20.0 parts by mass or less, more preferably 0.5 parts by mass or more and 15.0 parts by mass or less, and still more preferably 1.0 part by mass or more and 10.0 parts by mass or less, based on 100 parts by mass of the toner particles, from the viewpoint of charging stability.

When the amount of the composite particles contained is 0.1 parts by mass or more and 20.0 parts by mass or less, the detachment of the composite particles from a fixed image is inhibited to provide the effect of inhibiting the end portion soiling.

### Release Agent

The toner according to an embodiment of the present disclosure contains the release agent. When the penetration of the release agent is 4 or less, the external additive can be fixed onto the fixed image, thus providing the effect of inhibiting the end portion soiling. The penetration of the release agent can be controlled by controlling the molecular weight and composition of the release agent.

The amount of the release agent contained can be 3.0 parts by mass or more and 15.0 parts by mass or less based on 100.0 parts by mass of the binder resin. Within this range, the detachment of the external additive from a fixed image is inhibited to easily provide the effect of inhibiting the end portion soiling.

Examples of the release agent that can be used in an embodiment of the present disclosure include aliphatic hydrocarbon waxes, such as polyethylene, polypropylene, olefin copolymers, and Fischer-Tropsch wax; oxidized waxes of aliphatic hydrocarbon waxes, such as oxidized polyethylene wax; waxes mainly composed of fatty esters, such as carnauba wax, behenyl behenate, and montanate wax; and waxes in which fatty esters have been partially or completely deoxidized, such as deoxidized carnauba wax.

In particular, aliphatic hydrocarbon waxes and ester waxes, such as behenyl behenate, can be used. Examples thereof include hydrocarbons produced by radical polymerization of alkylene under high pressure or polymerization of alkylene under low pressure in the presence of a Ziegler catalyst or a metallocene catalyst; Fischer-Tropsch wax synthesized from coal or natural gas; paraffin wax; olefin polymers produced by pyrolysis of high-molecular-weight olefin polymers; synthetic hydrocarbon waxes produced from the distillation residue of hydrocarbons obtained by the Arge process from a synthesis gas containing carbon monoxide and hydrogen, or synthetic hydrocarbon waxes produced by hydrogenating these. Hydrocarbon waxes separated by a press sweating method, a solvent method, a vacuum distillation, or a fractional crystallization method can be used. Among paraffin waxes, n-paraffin wax and Fischer-Tropsch wax, which are mainly composed of linear components, can be used from the viewpoint of durable stability because they have a narrow molecular weight distribution.

Specific examples of the ester wax that can be used include monoester waxes, such as behenyl behenate, stearyl stearate, pentaerythritol tetrabehenate, pentaerythritol tetrastearate, dipentaerythritol tetrastearate, glycerol tribehenate, glycerol tristearate, diglycerol hexabehenate, stearyl sebacate, trimethylolpropane behenate, distearyl succinate, glycerol 1,2-hydrostearate, glycerol monobehenate, and tristearyl citrate; and polyfunctional ester waxes. Among these waxes, behenyl behenate can be used from the viewpoints of inhibiting the end portion soiling and low-temperature fixability. These waxes may be used alone or in combination of two or more.

### Toner Particles

### Binder Resin

The toner particles used in an embodiment of the present disclosure can contain a known binder resin. Examples of the binder resin are described below.

Examples thereof include styrene-based resins, styrene-based copolymer resins, polyester resins, polyol resins, polyvinyl chloride resins, phenolic resins, natural resin-modified phenolic resins, natural resin-modified maleic acid resins, acrylic resins, methacrylic resins, polyvinyl acetate, silicone resins, polyurethane resins, polyamide resins, furan resins, epoxy resins, xylene resins, polyvinyl butyral, terpene resins, coumarone-indene resins, and petroleum-based resins. Styrene-based copolymer resins, polyester resins, and hybrid resins in which polyester resins and styrene-based copolymer resins are mixed or partially reacted with each other can be used. In particular, a polyester resin can be used from the viewpoints of inhibiting the end portion soiling and improving the charging stability. Components constituting the polyester resin will be described in detail. The following components can be used singly or in combination of two or more, in accordance with the type and application.

Examples of a divalent acid component constituting the polyester resin include the following dicarboxylic acids or derivatives thereof. Examples thereof include benzenedicarboxylic acids, such as phthalic acid, terephthalic acid, and isophthalic acid, anhydrides thereof, such as phthalic anhydride, and lower alkyl esters thereof; alkyl dicarboxylic acids, such as succinic acid, adipic acid, sebacic acid, and azelaic acid, anhydrides thereof, and lower alkyl esters thereof; alkenylsuccinic acids and alkylsuccinic acids, each having 1 or more and 50 or less carbon atoms on average, anhydrides thereof, and lower alkyl esters thereof; and unsaturated dicarboxylic acids, such as fumaric acid, maleic acid, citraconic acid, and itaconic acid, anhydrides thereof, and lower alkyl esters thereof. Examples of an alkyl group in the lower alkyl esters include a methyl group, an ethyl group, a propyl group, and an isopropyl group.

Examples of the dihydric alcohol component constituting the polyester resin are described below.

Examples thereof include ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenol and derivatives thereof represented by formula (I-1), and diols represented by formula (I-2):

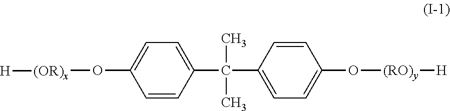

where in formula (I-1), each R is an ethylene group or a propylene group, x and y are each an integer of 0 or more, and the average value of x+y is 0 or more and 10 or less, and

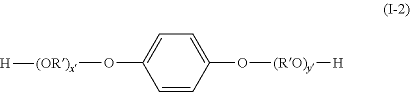

where in formula (I-2), each R′ is an ethylene group or a propylene group, x′ and y′ are each an integer of 0 or more, and the average value of x′+y′ is 0 or more and 10 or less.

The polyester resin may contain, as constituent components, a trivalent or higher carboxylic acid compound and a trihydric or higher alcohol compound in addition to the above-mentioned divalent carboxylic acid compound and dihydric alcohol compound.

Examples of the trivalent or higher carboxylic acid compound include, but are not limited to, trimellitic acid, trimellitic anhydride, and pyromellitic acid. Examples of the alcohol compound having a trihydric or higher include trimethylolpropane, pentaerythritol, and glycerol.

The polyester resin may contain, in addition to the above-mentioned compounds, a monovalent carboxylic acid compound and a monohydric alcohol compound as constituent components. Specific examples of the monovalent carboxylic acid compound include palmitic acid, stearic acid, arachidic acid, and behenic acid. Further examples thereof include cerotic acid, heptacosanoic acid, montanic acid, melissic acid, lacceroic acid, tetracontanoic acid, and pentacontanoic acid.

Examples of the monohydric alcohol compound include behenyl alcohol, ceryl alcohol, melissyl alcohol, and tetracontanol.

In an embodiment of the present disclosure, any known method for producing a polyester can be used without limitation. For example, the above-mentioned divalent carboxylic acid compound and dihydric alcohol compound are polymerized through an esterification reaction or an ester exchange reaction and a condensation reaction to produce a polyester resin. The polymerization temperature can be, but is not particularly limited to, in the range of 180° C. or higher and 290° C. or lower. In the polymerization to produce the polyester resin, for example, a polymerization catalyst, such as a titanium-based catalyst, a tin-based catalyst, zinc acetate, antimony trioxide, or germanium dioxide can be used.

The molecular weight of the binder resin in an embodiment of the present disclosure is preferably 4,000 or more and 100,000 or less, more preferably 6,000 or more and 40,000 or less, in terms of molecular weight distribution by gel permeation chromatography (GPC). This leads to good inhibition of the end portion soiling, good charging stability, and good low-temperature fixability.

The glass transition temperature Tg of the binder resin in an embodiment of the present disclosure is preferably 50° C. or higher 70° C. or lower, more preferably 55° C. or higher and 65° C. or lower, from the viewpoints of inhibiting the end portion soiling, the charging stability, and the low-temperature fixability.

The acid value of the binder resin in an embodiment of the present disclosure can be 5.0 mgKOH/g or more.

The acid value can be 10.0 mgKOH/g or more, from the viewpoints of inhibiting the end portion soiling, the charging stability, and the low-temperature fixability.

### Colorant

The toner according to an embodiment of the present disclosure can be used as any of a one-component magnetic toner, a one-component non-magnetic toner, and a two-component non-magnetic toner.

When the toner is used as a one-component magnetic toner, magnetic iron oxide particles can be used as a colorant. Examples of the material of the magnetic iron oxide particles contained in the one-component magnetic toner include magnetic iron oxides, such as magnetite, maghemite, ferrite; magnetic iron oxides including other metal oxides; metals, such as Fe, Co, and Ni; alloys of these metals with metals, such as Al, Co, Cu, Pb, Mg, Ni, Sn, Zn, Sb, Be, Bi, Cd, Ca, Mn, Se, Ti, W, and V; and mixtures thereof. The magnetic iron oxide particle content can be 30 parts by mass or more and 150 parts by mass or less based on 100 parts by mass of the binder resin.

Examples of the colorant used in a one-component non-magnetic toner and a two-component non-magnetic toner are described below.

Examples of black pigments that can be used include carbon blacks, such as furnace black, channel black, acetylene black, thermal black, and lamp black; and magnetic powders, such as magnetite and ferrite.

As a colorant for a yellow color, a pigment or a dye can be used. Examples of the pigment include C.I. Pigment Yellow 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, and 191, and C.I. Vat Yellow 1, 3, and 20. Examples of the dye include C.I. Solvent Yellow 19, 44, 77, 79, 81, 82, 93, 98, 103, 104, 112, and 162. These may be used alone or in combination of two or more.

As a colorant for a cyan color, a pigment or a dye can be used. Examples of the pigment include C.I. Pigment Blue 1, 7, 15, 15:1, 15:2, 15:3, 15:4, 16, 17, 60, 62, and 66, C.I. Vat Blue 6, and C.I. Acid Blue 45. Examples of the dye include C.I. Solvent Blue 25, 36, 60, 70, 93, and 95. These may be used alone or in combination of two or more.

As a colorant for a magenta color, a pigment or a dye can be used. Examples of the pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, and 254, C.I. Pigment Violet 19, C.I. Vat Red 1, 2, 10, 13, 15, 23, 29, and 35. Examples of the dye for magenta include oil-soluble dyes, such as C.I. Solvent Red 1, 3, 8, 23, 24, 25, 27, 30, 49, 52, 58, 63, 81, 82, 83, 84, 100, 109, 111, 121, and 122, C.I. Disperse Red 9, C.I. Solvent Violet 8, 13, 14, 21, and 27, and C.I. Disperse Violet 1; and Basic dyes, such as C.I. Basic Red 1, 2, 9, 12, 13, 14, 15, 17, 18, 22, 23, 24, 27, 29, 32, 34, 35, 36, 37, 38, 39, and 40, and C.I. Basic Violet 1, 3, 7, 10, 14, 15, 21, 25, 26, 27, and 28. These may be used alone or in combination of two or more. In particular, Pigment Red 122 can be used.

The colorant content can be 0.1 parts by mass or more and 20 parts by mass or less based on 100 parts by mass of the binder resin.

### Charge Control Agent

In the toner according to an embodiment of the present disclosure, a known charge control agent can be used. Examples of the known charge control agent include azo iron compounds, azo chromium compounds, azo manganese compounds, azo cobalt compounds, azo zirconium compounds, chromium compounds of carboxylic acid derivatives, zinc compounds of carboxylic acid derivatives, aluminum compounds of carboxylic acid derivatives, and zirconium compounds of carboxylic acid derivatives. The carboxylic acid derivative can be an aromatic hydroxycarboxylic acid. A charge control resin can also be used. One or more charge control agents may be used in combination, as needed. The charge control agent can be added in an amount of 0.1 parts by mass or more and 10 parts by mass or less based on 100 parts by mass of the binder resin.

### Additional Fine Inorganic Powder

In the toner according to an embodiment of the present disclosure, an additional fine inorganic powder can also be used in addition to the above-mentioned external additive for toner, as needed. The fine inorganic powder may be added internally to the toner particles, or may be mixed with the toner base particles as an external additive. As an external additive, fine inorganic powder composed of a material, such as silica, can be used. The fine inorganic powder can be hydrophobized with a hydrophobizing agent, such as a silane compound, silicone oil, or a mixture thereof.

As an external additive for improving flowability, fine inorganic powder having a specific surface area of 50 m²/g or more and 400 m²/g or less can be used. To achieve both an improvement in flowability and the stabilization of the durability, inorganic fine particles having a specific surface area within the above range may be used in combination.

The fine inorganic powder can be used in an amount of 0.1 parts by mass or more and 10.0 parts by mass or less based on 100 parts by mass of the toner particles. When the above range is satisfied, a durable stability effect is easily provided.

### Production Method

A method for producing the toner particles is not limited to a particular method. Any of known production methods, such as a suspension polymerization method, an emulsion aggregation method, a melt-kneading method, and a dissolution suspension method, can be used.

The resulting toner particles may be mixed with the external additive for toner according to an embodiment of the present disclosure, and, if necessary, with an additional external additive to provide a toner. The toner particles can be mixed with the external additive for toner according to an embodiment of the present disclosure and an additional external additive using a mixing device, such as a double-cone mixer, a V-type mixer, a drum-type mixer, a super mixer, a Henschel mixer, a Nauta mixer, a Mechano Hybrid (manufactured by Nippon Coke & Engineering Co., Ltd.), or a Nobilta (manufactured by Hosokawa Micron Corporation).

### Carrier

The toner according to an embodiment of the present disclosure may be mixed with a carrier and used as a two-component developer. As the carrier, a typical carrier, such as ferrite or magnetite, or a resin-coated carrier can be used. Magnetic material-dispersed resin particles in which a magnetic material powder is dispersed in a resin component, or porous magnetic particles containing a resin in their void portions can be used.

Examples of a magnetic material component that can be used in the magnetic material-dispersed resin particles include various magnetic iron compound particle powders, such as magnetic iron oxide particle powders, e.g., magnetite particle powders, maghemite particle powders, and these powders each containing at least one selected from silicon oxide, silicon hydroxide, aluminum oxide, and aluminum hydroxide; magnetoplumbite-type ferrite particle powders containing barium, strontium, or barium-strontium; and spinel-type ferrite particle powders containing at least one selected from manganese, nickel, zinc, lithium, and magnesium.

In addition to the magnetic component, non-magnetic inorganic compound particle powders, such as non-magnetic iron oxide particle powders, e.g., a hematite particle powder, non-magnetic hydrous ferric hydroxide particle powders, e.g., a goethite particle powder, and non-magnetic inorganic compound particle powders, e.g., a titanium oxide particle powder, a silica particle powder, a talc particle powder, an alumina particle powder, a barium sulfate particle powder, a barium carbonate particle powder, a cadmium yellow particle powder, a calcium carbonate particle powder, and a zinc oxide particle powder, may be used in combination with the magnetic iron compound particle powder.

Examples of the material of the porous magnetic core particles include magnetite and ferrite.

A specific example of ferrite is represented by the following general formula:

(M1₂O)ₓ(M2O)_{y}(Fe₂O₃)_{z}

where in the above formula, M1 is a monovalent metal, M2 is a divalent metal, and when x+y+z=1.0, x and y are each 0≤(x, y)≤0.8, and z is 0.2<z<1.0.

In the formula, M1 and M2 can be at least one metal atom selected from the group consisting of Li, Fe, Mn, Mg, Sr, Cu, Zn, and Ca. Ni, Co, Ba, Y, V, Bi, In, Ta, Zr, B, Mo, Na, Sn, Ti, Cr, Al, Si, and rare-earth elements can also be used.

The resin-coated carrier includes magnetic carrier core particles and a resin coating layer covering the surface of each of the magnetic carrier core particles. Examples of a resin used in the resin coating layer include acrylic resins, such as acrylate copolymers and methacrylate copolymers; styrene-acrylic resins, such as styrene-acrylate copolymers and styrene-methacrylate copolymers; fluorine-containing resins, such as polytetrafluoroethylene, tetrafluoroethylene-hexafluoropropylene copolymers, monochlorotrifluoroethylene polymers, and polyvinylidene fluoride; silicone resins; polyester resins; polyamide resins; polyvinyl butyral; aminoacrylate resins; ionomer resins; and polyphenylene sulfide resins. These resins can be used alone or in combination of two or more. Among these, in particular, from the viewpoint of the charging stability, a copolymer containing a methacrylate having an alicyclic hydrocarbon group can be used. Examples of the methacrylate having an alicyclic hydrocarbon group include cyclobutyl acrylate, cyclopentyl acrylate, cyclohexyl acrylate, cycloheptyl acrylate, dicyclopentenyl acrylate, dicyclopentanyl acrylate, cyclobutyl methacrylate, cyclopentyl methacrylate, cyclohexyl methacrylate, cycloheptyl methacrylate, dicyclopentenyl methacrylate, and dicyclopentanyl methacrylate. The alicyclic hydrocarbon group can be a cycloalkyl group. The alicyclic hydrocarbon group preferably has 3 to 10 carbon atoms, more preferably 4 to 8 carbon atoms. These may be used alone or in combination of two or more.

To enhance the charging stability, the resin coating layer can contain a macromonomer as a copolymerizable component from the viewpoints of increasing the adhesion between the magnetic carrier core particles and the resin coating layer and inhibiting the local peeling of the resin coating layer. A specific example of the macromonomer is presented by the following formula (B):

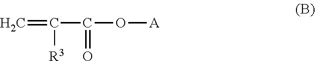

where in formula (B), A is a polymer moiety from one or more compounds selected from the group consisting of methyl acrylate, methyl methacrylate, butyl acrylate, butyl methacrylate, 2-ethylhexyl acrylate, 2-ethylhexyl methacrylate, styrene, acrylonitrile, and methacrylonitrile as polymerizable components, and R³ is H or CH₃.

### Methods for Measuring Physical Properties

Methods for measuring various physical properties will be described below.

Separation of Fine Particles and Toner Particles from Toner

The respective physical properties may also be measured through the use of fine particles separated from a toner by the following method.

First, 200 g of sucrose (manufactured by Kishida Chemical Co., Ltd.) is added to 100 mL of ion-exchanged water and then dissolved on a hot water bath to prepare a concentrated sucrose solution. A dispersion is prepared by introducing 31 g of the resulting concentrated sucrose solution and 6 mL of Contaminon N (a 10% by mass aqueous solution of a neutral detergent for cleaning a precision measuring instrument, the solution having a pH of 7 and containing a nonionic surfactant, an anionic surfactant, and an organic builder, manufactured from Wako Pure Chemical Industries, Ltd.) into a centrifuge tube. To this dispersion, 1 g of the toner is added. The clumps of the toner are broken up with a spatula or the like.

The centrifuge tube is shaken with a shaker for 20 minutes at 350 strokes per minute. After shaking, the solution is transferred to a glass tube (50 mL) for a swing rotor and centrifuged in a centrifuge at 3,500 rpm for 30 minutes. After the centrifugation, in the glass tube, the toner is present in the uppermost layer, and the fine particles are present in the aqueous solution side in the lower layer. The lower aqueous solution is collected and centrifuged to separate the sucrose from the fine particles, and the fine particles are collected. If necessary, centrifugation is repeated to sufficiently separate the particles. Then the dispersion is dried, and the fine particles are collected.

When multiple external additives are contained, the external additive according to an embodiment of the present disclosure can be selectively separated by, for example, a centrifugal separation method.

### Method for Measuring Number-Average Diameter of Primary Particle of External Additive

The number-average diameter of primary particles of the external additive can be determined by measurement using a centrifugal sedimentation method. Specifically, 0.01 g of dry external additive particles are placed in a 25-mL glass vial, and then 0.2 g of a 5% Triton solution and 19.8 g of RO water are added thereto, preparing a solution. A probe (end of the tip) of an ultrasonic disperser is immersed in the solution, and ultrasonic dispersion is performed for 15 minutes at an output power of 20 W, thereby providing a dispersion. Subsequently, the number-average diameter of the primary particles of the dispersion is measured by a centrifugal sedimentation particle size distribution measuring instrument DC24000 manufactured by CPS Instruments, Inc. The rotation speed of a disc is set to 18,000 rpm, and the true density is set to 1.3 g/cm³. Before the measurement, the instrument is calibrated using polyvinyl chloride particles having an average particle size of 0.476 μm.

### Method for Measuring Young's Modulus of External Additive

The Young's modulus of the external additive is determined by a microcompression test using Hysitron PI 85L Picoindenter (manufactured by Bruker).

The Young's modulus (MPa) is calculated from the slope of a profile (load displacement curve) of a displacement (nm) and a test force (μN) obtained by measurement.

### Device and Jig

Base system: Hysitron PI 85L
Measurement indenter: circular flat-end indenter with a diameter of 1 μm
SEM used: Thermo Fisher Versa 3D
SEM conditions: −10° tilt, 13 pA at 10 keV

### Measurement Conditions

Measurement mode: displacement control
Maximum displacement: 30 nm
Displacement rate: 1 nm/sec
Retention time: 2 sec
Unloading rate: 5 nm/sec

### Analysis Method

The Hertz analysis is applied to a curve obtained at the time of compression by from 0 nm to 10 nm in the resultant load displacement curve, to thereby calculate the Young's modulus of the fine particles.

### Sample Preparation

### Fine Particles Adhering to a Silicon Wafer

### Method for Measuring Young's Modulus of Fine Particles B

First, the composition of the fine particles B is identified. The measurement is performed with a scanning electron microscope “S-4800” (trade name: Hitachi, Ltd.). An external additive having a difference in image contrast between a portion derived from the fine particles B, which are composed of an inorganic substance, and a portion derived from the fine particles A, which are composed of an organic substance, is defined as an external additive for toner according to an embodiment of the present disclosure. An external additive that does not have the difference in image contrast is defined as an external additive other than the external additive for toner according to an embodiment of the present disclosure and is distinguished. The inorganic fine particles B are observed to have a higher brightness.

The external additive is observed, and the compositions of the fine particles A and the fine particles B are identified with an energy-dispersive X-ray analyzer in a field of view at a magnification of up to two million times. After the composition of the fine particles B is identified, fine particles having the same composition as the fine particles B are prepared. Then, the same measurement as the measurement of the Young's modulus of the above-mentioned external additive is performed to determine the Young's modulus of the fine particles B.

### Method for Measuring Embedding Ratio of Fine Particle B

The external additive is sufficiently dispersed in a visible-light-curable resin (Aronix, LCR series D800, manufactured by Toagosei Co., Ltd.) and then cured by irradiation with short wavelength light. The resulting cured product is cut using an ultramicrotome equipped with a diamond knife to prepare a thin sample having a thickness of 250 nm. A section of the external additive is observed by observing the cut sample at a magnification of 40,000× to 50,000× with a transmission electron microscope (electron microscope JEM-2800 (TEM-EDX), manufactured by JEOL Ltd.). The diameter of a fine particle B and the depth of the fine particle B embedded in a fine particle A are measured from the sectional image. Five particles of the fine particles B are randomly selected for one particle of the external additive. The embedding ratio of each of the fine particles B is calculated by the following formula. The number of external additive particles analyzed is 20 or more. The average value is defined as the embedding ratio of the fine particles B.

$$Embedding ratio of fine particle B ( \% ) = ( depth of fine particle B embedded in fine particle A / diameter of fine particle B ) \times 100$$

### Method for Measuring Sb/Sa of External Additive

The section of the external additive is observed by the above-mentioned method, and Sb/Sa of the external additive is calculated by image analysis. Image analysis software, such as ImageJ, is used. From an image obtained by the observation, the area Sa of the section X of one particle of the fine particles A is calculated. Then, the total area Sb of the fine particles B that are entirely contained in the section X and that are present in an unexposed state is calculated. The number of external additive particles analyzed is 100, and the average value was defined as the value of Sb/Sa in an embodiment of the present disclosure.

### Method for Measuring BD/AD of External Additive

The section of the external additive is observed by the above-mentioned method, and the BD/AD of the external additive is calculated. The particle sizes of the fine particles A and the fine particles B are calculated from the images obtained by observation. The number of external additive particles analyzed is 20, and the average value is defined as the value of BD/AD in an embodiment of the present disclosure.

### Method for Measuring Proportion of Constituent Compound of External Additive by Solid-State ²⁹Si-NMR

In solid-state ²⁹Si-NMR, peaks are detected in different shift ranges in accordance with the structure of a functional group that bonds to Si in the constituent compound of the external additive. Each peak position is identified using a standard sample to identify the corresponding structure bonded to Si. The proportion of each constituent compound present can be calculated from the resulting peak area. The proportions of the peak areas of an M unit structure, a D unit structure (c), a T unit structure (b), and a Q unit structure (a) to the total peak area can be determined by calculation.

The specific measurement conditions for the solid-state ²⁹Si-NMR are described below.
Instrument: JNM-ECX5002 (JEOL RESONANCE Co., Ltd.)
Temperature: room temperature
Measurement method: DD/MAS method ²⁹Si 45°
Sample tube: zirconia Ø3.2 mm
Sample: filled in a test tube in powder form
Sample rotation speed: 10 kHz
Relaxation delay: 180 s
Scan: 2,000 scans

After the measurement, the peaks of different silane components having different substituents and bonding groups in the sample are separated into the following M unit structure, D unit structure (c), T unit structure (b), and Q unit structure (a) by curve fitting, and the respective peak areas are calculated.

Curve fitting is performed using EXcalibur for Windows (registered trademark), version 4.2 (EX series) of software for JNM-EX400 manufactured by JEOL Ltd. “1D Pro” from the menu icon is clicked, to read measurement data. Next, “Curve fitting function” is selected from “Command” on the menu bar, to perform curve fitting. Curve fitting is performed for each component so as to minimize a difference (composite peak difference) between a composite peak obtained by combining the peaks obtained by curve fitting, and a peak of the result of the measurement.
M unit structure: (Ra)(Rb)(Rc)SiO_{1/2}
D unit structure: (Rd)(Re)Si(O_{1/2})₂ (c)
T unit structure: RfSi(O_{1/2})₃ (b)
Q unit structure: Si(O_{1/2})₄ (a)

In the formulae, Ra, Rb, Rc, Rd, Re, and Rf are each an organic group, such as a hydrocarbon group having 1 or more and 6 or less carbon atoms (for example, an alkyl group or an alkoxy group), a halogen atom, or a hydroxy group, the organic group being bonded to silicon. The proportions of (a), (b), and (c) in the external additive are calculated from the peak area corresponding to the structure represented by formula (a), the peak area corresponding to the structure represented by formula (b), and the peak area corresponding to the structure represented by formula (c), these peak areas being determined by the measurement. When the structure needs to be examined in more detail, the results of ¹³C-NMR and ¹H-NMR may be used in addition to the results of ²⁹Si-NMR to identify the structure.

### Method for Measuring True Specific Gravity of External Additive

The true specific gravity of the external additive is measured by a dry-process automatic densitometer, Autopycnometer (manufactured by Yuasa Ionics). The conditions are described below.
Cell: SM cell (10 mL)
Amount of sample: 0.05 g

This measurement method is based on the gas displacement method, and the true specific gravity of solid and liquid is measured by the method.

As with the liquid displacement method, the measurement method is based on Archimedes' principle. However, a gas (argon gas) is used as a displacement medium; hence, the measurement method exhibits high accuracy for micropores.

### Method for Measuring Surface Treatment Agent of External Additive

The surface treatment agent for the external additive is analyzed by pyrolysis-GC-MS (gas chromatography-mass spectrometry). Specifically, the
measurement conditions are described below.
Instrument: GC6890A (manufactured by Agilent Technologies, Inc.), pyrolyzer (manufactured by Japan Analytical Industry Co., Ltd.)
Column: HP-5 ms, 30 m
Pyrolysis temperature: 590° C.

The position of each peak in a profile obtained by the measurement is identified using a standard sample, thereby identifying the surface treatment agent of the external additive.

Separation of Release Agent from Toner

The various physical properties can also be measured using the release agent separated from the toner by the following method.

First, 200 g of sucrose (manufactured by Kishida Chemical Co., Ltd.) is added to 100 mL of ion-exchanged water and then dissolved on a hot water bath to prepare a concentrated sucrose solution. A dispersion is prepared by introducing 31 g of the resulting concentrated sucrose solution and 6 mL of Contaminon N (a 10% by mass aqueous solution of a neutral detergent for cleaning a precision measuring instrument, the solution having a pH of 7 and containing a nonionic surfactant, an anionic surfactant, and an organic builder, manufactured from Wako Pure Chemical Industries, Ltd.) into a centrifuge tube. To this dispersion, 1 g of the toner is added. The clumps of the toner are broken up with a spatula or the like.

The centrifuge tube is shaken with a shaker for 20 minutes at 350 strokes per minute. After shaking, the solution is transferred to a glass tube (50 mL) for a swing rotor and centrifuged in a centrifuge at 3,500 rpm for 30 minutes. After the centrifugation, in the glass tube, the toner is present in the uppermost layer, and the fine particles are present in the aqueous solution side in the lower layer. The topmost toner is collected, dried, and dispersed in hexane. The mixture is stirred at 25° C. for 24 hours. The dispersion is filtered. The hexane solution is recovered and evaporated to collect the release agent.

### Method for Measuring Penetration of Release Agent

The penetration of the release agent in an embodiment of the present disclosure is a value measured in accordance with JIS K-2207. This is a numerical value, expressed in 0.1 mm units, of the depth of penetration when an indenter having a diameter of about 1 mm and a conical tip with a peak angle of 9° is caused to penetrate a sample under a fixed load. The test conditions in an embodiment of the present disclosure include a sample temperature of 25° C., an applied load of 100 g, and a penetration time of 5 seconds.

### Method for Measuring Acid Value of Binder Resin

The acid value is the number of milligrams of potassium hydroxide required for neutralizing acid components, such as a free fatty acid and a resin acid, contained in 1 g of a sample. The acid value is measured in accordance with JIS K0070-1992 as described below.

### (1) Reagent

First, 1.0 g of phenolphthalein is dissolved in 90 mL of ethyl alcohol (95% by volume). The solution is diluted with ion-exchanged water to 100 mL, thereby resulting in a phenolphthalein solution.

Then 7 g of special grade potassium hydroxide is dissolved in 5 mL of water. The solution is diluted with ethyl alcohol (95% by volume) to 1 L. The resulting solution is placed in an alkali-resistant container so as to avoid contact with, for example, carbon dioxide gas, and allowed to stand for three days. Then, the solution is filtered to provide a potassium hydroxide solution. The resulting potassium hydroxide solution is stored in an alkali-resistant container. In an Erlenmeyer flask, 25 mL of 0.1 mol/L hydrochloric acid is placed. Several drops of the phenolphthalein solution are added thereto. Titration is performed with the potassium hydroxide solution. The factor of the potassium hydroxide solution is determined from the amount of the potassium hydroxide solution required for neutralization. The 0.1 mol/L hydrochloric acid used is prepared according to JIS K 8001-1998.

### (2) Operation

### (A) Main Test

In a 200-mL Erlenmeyer flask, 2.0 g of a ground sample is accurately weighed. Then 100 mL of a toluene-ethanol (2:1) mixed solution is added thereto. The sample is dissolved over 5 hours. Several drops of the phenolphthalein solution are added as an indicator. Titration is performed with the potassium hydroxide solution. The end point of the titration is when the light crimson color of the indicator lasts about 30 seconds.

### (B) Blank Test

Titration is performed in the same manner as in the above operation, except that no sample is used (that is, only the toluene/ethanol (2:1) mixed solution is used). (3) The results obtained are substituted into the following equation to calculate the acid value:

$$A = [ ( C - B ) \times f \times 5.61 ] / S$$

where A is the acid value (mgKOH/g), B is the amount (mL) of the potassium hydroxide solution added in the blank test, C is the amount (mL) of the potassium hydroxide solution added in the main test, f is the factor of the potassium hydroxide solution, and S is the mass of the sample (g).
Measurement of Acid Value of Polyester Resin from Toner

The acid value of the polyester resin from the toner can be measured by the following method. The polyester resin is separated from the toner by the following method, and the acid value is measured.

The toner is dissolved in tetrahydrofuran (THF). The solvent is distilled off from the resulting soluble fraction under reduced pressure to give a THF-soluble component of the toner. The resulting THF-soluble component of the toner is dissolved in chloroform to prepare a sample solution having a concentration of 25 mg/mL.

Into the following apparatus, 3.5 mL of the resulting sample solution is injected. A component having a molecular weight of 2,000 or more is separated as a resin component under the following conditions.
Preparative gel permeation chromatograph: preparative HPLC LC-980 manufactured by
Nippon Analytical Industry Co., Ltd.
Preparative columns: JAIGEL 3H and JAIGEL 5H (manufactured by Nippon Analytical Industry Co., Ltd.)
Eluent: chloroform
Flow rate: 3.5 mL/min

The high-molecular-weight component derived from the resin is fractionated. The solvent is distilled off under reduced pressure. Drying is performed in an atmosphere of 90° C. for 24 hours under reduced pressure. The above operation is repeated until about 2.0 g of the resin component is obtained.

The resulting sample is used to measure the acid value according to the above procedure.

### Measurement of Glass Transition Temperature (Tg) of Binder Resin

The glass transition temperature of the binder resin is measured according to ASTM D3418-82 using a differential scanning calorimeter “Q2000” (manufactured by TA Instruments).

The temperature at the detection unit of the instrument is corrected on the basis of the melting points of indium and zinc. The amount of heat is corrected on the basis of the heat of fusion of indium.

Specifically, about 3 mg of a resin or a toner is accurately weighed and placed in an aluminum pan. The measurement is performed using an empty aluminum pan as a reference under the following conditions.
Heating rate: 10° C./min
Measurement start temperature: 20° C.
Measurement end temperature: 180° C.

The measurement is performed in the measurement range of 20° C. to 180° C. at a heating rate of 10° C./min. The temperature is increased to 180° C. once, held for 10 minutes, reduced to 20° C., and then increased again. In the second temperature increase process, a change in specific heat is obtained in the temperature range of 20° C. to 100° C. The temperature at the intersection of the differential thermal curve and a straight line equidistant along the vertical axis from the “baseline before the change in specific heat occurs” and the “baseline after the change in specific heat occurs” is defined as the glass transition temperature (Tg, also referred to as a “midpoint glass transition temperature”) of the resin.

### Molecular Weight Measurement of Binder Resin and Toner

The molecular weight distribution of THF-soluble fraction of the binder resin and the toner is measured by gel permeation chromatography (GPC) as described below.

The toner is dissolved in THE over 24 hours at room temperature to prepare a solution. The resulting solution is filtered through a solvent-resistant membrane filter (trade name “Maeshori Disc”, manufactured by Tosoh Corporation) having a pore size of 0.2 μm to prepare a sample solution. The sample solution is adjusted in such a manner that the concentration of THF-soluble components is about 0.8% by mass. The sample solution is used to measure the molecular weight under the following conditions. Instrument: HLC-8120 GPC (detector: RI) (manufactured by Tosoh Corporation) Column: connection of seven columns of Shodex KF-801, 802, 803, 804, 805, 806, and 807 (manufactured by Showa Denko K.K.)
Eluent: THF
Flow rate: 1.0 mL/min
Oven temperature: 40.0° C.
Sample injection volume: 0.10 mL

A molecular weight calibration curve that has been prepared using, for example, the following standard polystyrene resins, manufactured by Tosoh Corporation, is used to calculate the molecular weight of a sample.

Standard polystyrene resin: Trade name “TSK Standard Polystyrene F-850, F-450, F-288, F-128, F-80, F-40, F-20, F-10, F-4, F-2, F-1, A-5000, A-2500, A-1000, and A-500” Method for Measuring Weight-average Particle Size (D4) of Toner Particles

A precision particle size distribution measuring apparatus (a Coulter Counter Multisizer 3 (registered trademark) manufactured by Beckman Coulter) equipped with a 100-μm-aperture tube and based on an aperture impedance method and dedicated software for the measurement apparatus (Beckman Coulter Multisizer 3 Version 3.51 manufactured by Beckman Coulter) for setting measurement conditions and analysis of measured data are used for measurement. The measurement is performed using 25,000 effective measurement channels. The measurement data is analyzed to calculate the weight-average particle size (D4) of the toner particles.

A solution prepared by dissolving special grade sodium chloride in ion-exchanged water at a concentration of about 1% by mass, such as “ISOTON II” (manufactured by Beckman Coulter), can be used as an aqueous electrolyte solution used in the measurement.

The dedicated software was set up in the following way before carrying out the measurement and analysis.

On the “Change standard operating method (SOM)” screen of the dedicated software, the total count number in the control mode is set to 50,000 particles, the number of measurements is set to 1, and the Kd value is set to the value obtained using “Standard Particles 10.0 μm” (manufactured by Beckman Coulter). Pressing the threshold/noise level measurement button automatically sets the threshold and the noise level. The current is set to 1,600 μA, the gain is set to 2, the electrolyte solution is set to ISOTON II, and “Flush aperture tube after measurement” is checked.

On the “Conversion setting from pulse to particle size” screen of the dedicated software, the bin interval is set to logarithmic particle size, the particle size bin is set to 256 particle size bin, and the particle size range is set to 2 μm or more and 60 μm or less.

The specific measurement method is described below.

(1) About 200 mL of the aqueous electrolyte solution is placed in a 250 mL round-bottom glass beaker made exclusively for Multisizer 3. The beaker is placed at a sample stand. The stirring is performed with a stirrer rod in a counterclockwise direction at 24 revolutions per second. The “Aperture tube flush” function of the dedicated software is performed to remove dirt and air bubbles in the aperture tube.

(2) About 30 mL of the aqueous electrolyte solution is placed in a 100-mL flat-bottom glass beaker. About 0.3 mL of the diluted solution of Contaminon N (a 10% by mass aqueous solution of a neutral detergent for cleaning a precision measuring instrument, the solution having a pH of 7 and containing a nonionic surfactant, an anionic surfactant, and an organic builder, manufactured from Wako Pure Chemical Industries, Ltd.) diluted three times by mass with ion-exchanged water is added as a dispersant.

(3) An ultrasonic disperser (Ultrasonic Dispersion System Tetora 150 manufactured by Nikkaki Bios Co., Ltd.) is provided, the disperser having an electrical output of 120 W and including two built-in oscillators having an oscillation frequency of 50 kHz with their phases shifted by 180° from each other, and a water tank. A predetermined amount of ion-exchanged water is placed in a water tank, and 2 mL of the Contaminon N is then added to this water tank.

(4) The beaker described in (2) is placed in a beaker-fixing hole of the ultrasonic disperser, and then the ultrasonic disperser is operated. The height position of the beaker is adjusted in such a manner that the resonance state of the liquid surface of the aqueous electrolyte solution in the beaker is maximized.

(5) About 10 mg of the toner is added little by little to the aqueous electrolyte solution and dispersed while the aqueous electrolyte solution in the beaker described in (4) is irradiated with ultrasonic waves. The ultrasonic dispersion treatment is continued for another 60 seconds. During the ultrasonic dispersion, the water temperature in the water tank is appropriately adjusted to 10° C. or higher and 40° C. or lower.

(6) The aqueous electrolyte solution, described in (5), in which the toner has been dispersed is added dropwise using a pipette into the round-bottom beaker, described in (1), placed on the sample stand. The measurement concentration is adjusted to about 5%. The measurement is continued until the number of particles measured reaches 50,000.

(7) The measurement data is analyzed using the dedicated software provided with the apparatus to calculate the weight-average particle size (D4). When the dedicated software is set to Graph/Volume %, the “Average size” on the Analysis/Volume statistics (Arithmetic mean) screen is the weight-average particle size (D4).

### EXAMPLES

The basic configuration and features of the present disclosure have been described above. The present disclosure will be described in more detail below with reference to examples. However, the present disclosure is not limited to these examples. Unless otherwise specified, part(s) and % are based on mass.

### Production Example of Composite Particles C1

### 1. Hydrolysis and Polycondensation Step

(1) In a 500-mL beaker, 21.6 g of RO water, 135.0 g of methanol, 0.004 g of acetic acid as a catalyst, and 12.2 g of dimethyldimethoxysilane were placed. The mixture was stirred at 45° C. for 5 minutes.

(2) To the mixture, 2.0 g of 28% aqueous ammonia, 15.0 g of tetraethoxysilane, and 5.0 g of aqueous colloidal silica dispersion A (silica solid content: 40% by mass, number-average particle size of silica: 40 nm (0.04 μm)) were added. The mixture was stirred at 30° C. for 3.0 hours to prepare a raw material solution.

### 2. Granulation Step

First, 120.0 g of RO water was placed in a 1,000-mL beaker. The raw material solution prepared in the hydrolysis and polycondensation step was added dropwise thereto at 25° C. over a period of 5 minutes under stirring. The mixture was heated to 60° C. and stirred for 1.5 hours with the temperature maintained at 60° C., thereby preparing a dispersion of fine external additive particles.

### 3. Hydrophobization Step

To the dispersion of the fine external additive particles prepared in the above-described granulation step, 6.0 g of hexamethyldisilazane as a hydrophobizing agent was added. The mixture was stirred at 60° C. for 3.0 hours. The mixture was allowed to stand for 5 minutes. The resulting powder that had precipitated at the bottom of the solution was collected by suction filtration and dried under reduced pressure at 120° C. for 24 hours to give composite particles C1. The number-average diameter of primary particles of the composite particles C1 was 0.12 μm. Other physical properties are presented in Table 1.

### Production Example of Composite Particles C2

Composite particles C2 were produced in the same manner as in the production example of composite particles C1, except that in (1) of the hydrolysis and polycondensation step, the amount of dimethyldimethoxysilane was changed to 5.0 g, and in (2), the amount of tetraethoxysilane was changed to 10.2 g, and 12.0 g of trimethoxymethylsilane was added.

### Production Example of Composite Particles C3

Composite particles C3 were produced in the same manner as in the production example of composite particles C1, except that in (1) of the hydrolysis and polycondensation step, the amount of dimethyldimethoxysilane was changed to 7.2 g, and in (2), the amount of tetraethoxysilane was changed to 20.0 g.

### Production Example of Composite Particles C4

Composite particles C4 were produced in the same manner as in the production example of composite particles C1, except that in (1) of the hydrolysis and polycondensation step, the amount of dimethyldimethoxysilane was changed to 16.0 g, and in (2), the amount of tetraethoxysilane was changed to 11.2 g.

### Production Example of Composite Particles C5

Composite particles C5 were produced in the same manner as in the production example of composite particles C1, except that in (1) of the hydrolysis and polycondensation step, the amount of dimethyldimethoxysilane was changed to 7.2 g, and in (2), tetraethoxysilane was not added, and 20.0 g of trimethoxymethylsilane was added.

### Production Example of Composite Particles C6

Composite particles C6 were produced in the same manner as in the production example of composite particles C1, except that in (1) of the hydrolysis and polycondensation step, dimethyldimethoxysilane was not added, and 5.4 g of trimethoxymethylsilane was added, and in (2), the amount of tetraethoxysilane was changed to 22.0 g.

### Production Example of Composite Particles C7

Composite particles C7 were produced in the same manner as in the production example of composite particles C1, except that in (2) of the hydrolysis and polycondensation step, aqueous colloidal silica dispersion B (silica solid content: 40% by mass, number-average particle size of silica: 20 nm (0.02 μm)) was used instead of aqueous colloidal silica dispersion A, the amount of 28% aqueous ammonia was changed to 3.0 g, and the stirring temperature was changed to 25° C.

### Production Example of Composite Particles C8

Composite particles C8 were produced in the same manner as in the production example of composite particles C1, except that in (2) of the hydrolysis and polycondensation step, the amount of 28% aqueous ammonia was changed to 1.0 g, and the stirring temperature was changed to 40° C.

### Production Example of Composite Particles C9

Composite particles C9 were produced in the same manner as in the production example of composite particles C1, except that in (2) of the hydrolysis and polycondensation step, aqueous colloidal silica dispersion C (silica solid content: 40% by mass, number-average particle size of silica: 10 nm (0.01 μm)) was used instead of aqueous colloidal silica dispersion A, the amount of 28% aqueous ammonia was changed to 3.0 g, and the stirring temperature was changed to 25° C.

### Production Example of Composite Particles C10

Composite particles C10 were produced in the same manner as in the production example of composite particles C1, except that in (2) of the hydrolysis and polycondensation step, the amount of 28% aqueous ammonia was changed to 1.0 g, the stirring temperature was changed to 40° C., and the stirring time was changed to 3.5 hours.

### Production Example of Composite Particles C11

Composite particles C11 were produced in the same manner as in the production example of composite particles C1, except that in (2) of the hydrolysis and polycondensation step, an aqueous alumina dispersion (alumina solid content: 30% by mass, number-average particle size of alumina: 40 nm (0.04 μm)) was used instead of aqueous colloidal silica dispersion A.

### Production Example of Composite Particles C12

Composite particles C12 were produced in the same manner as in the production example of composite particles C1, except that in (2) of the hydrolysis and polycondensation step, the amount of aqueous colloidal silica dispersion A added was changed to 10.0 g.

### Production Example of Composite Particles C13

Composite particles C13 were produced in the same manner as in the production example of composite particles C1, except that in (2) of the hydrolysis and polycondensation step, the amount of aqueous colloidal silica dispersion A added was changed to 15.0 g.

### Production Example of Composite Particles C14

Composite particles C14 were produced in the same manner as in the production example of composite particles C1, except that in (2) of the hydrolysis and polycondensation step, the amount of 28% aqueous ammonia was changed to 5.0 g, the stirring temperature was changed to 25° C., and the stirring time was changed to 2.0 hours.

### Production Example of Composite Particles C15

Composite particles C15 were produced in the same manner as in the production example of composite particles C1, except that in (2) of the hydrolysis and polycondensation step, aqueous colloidal silica dispersion B (silica solid content: 40% by mass, number-average particle size of silica: 10 nm (0.01 μm)) was used instead of aqueous colloidal silica dispersion A, the amount of 28% aqueous ammonia was changed to 1.0 g, the stirring temperature was changed to 45° C., and the stirring time was changed to 4.0 hours.

### Production Example of Composite Particles C16

Composite particles C16 were produced in the same manner as in the production example of composite particles C1, except that in (2) of the hydrolysis and polycondensation step, aqueous colloidal silica dispersion C (silica solid content: 40% by mass, number-average particle size of silica: 70 nm (0.07 μm)) was used instead of aqueous colloidal silica dispersion A, the amount of 28% aqueous ammonia was changed to 1.0 g, the stirring temperature was changed to 45° C., and the stirring time was changed to 4.0 hours.

### Production Example of Composite Particles C17

Composite particles C17 were produced in the same manner as in the production example of composite particles C1, except that in (1) of the hydrolysis and polycondensation step, 3.2 g of dimethyldimethoxysilane was added, and in (2), 24.0 g of tetraethoxysilane was added.

### Production Example of Composite Particles C18

In a 250-mL four-necked round-bottom flask equipped with an overhead stirrer, a condenser, and a thermocouple, 18.7 g of colloidal silica dispersion (silica solid content: 40% by mass, number-average particle size of silica: 30 nm (0.03 μm)), 125 mL of DI water, and 16.5 g (0.066 mol) of methacryloxypropyltrimethoxysilane were placed. The temperature was increased to 65° C., and the mixture was stirred at 120 rpm. Nitrogen gas was bubbled into the mixture for 30 minutes. After 3 hours, 0.16 g of 2,2′-azobis(isobutyronitrile), serving as a radical initiator, dissolved in 10 mL of ethanol was added, and the temperature was increased to 75° C.

The radical polymerization was allowed to proceed for 5 hours, followed by the addition of 3 mL of 1,1,1,3,3,3-hexamethyldisilazane to the mixture. The reaction was allowed to proceed for an additional 3 hours. The final mixture was filtered through a 170-mesh sieve to remove agglomerates. The dispersion was dried in a Pyrex (registered trademark) dish at 120° C. overnight to give composite particles C18.

### Production Example of Composite Particles C19

Composite particles C19 were produced in the same manner as in the production example of composite particles C1, except that in (2) of the hydrolysis and polycondensation step, a dispersion of fine particles of a polyester resin (polyester resin solid content: 25% by mass, number-average particle size of polyester resin: 50 nm (0.05 μm)) was used instead of aqueous colloidal silica dispersion A.

### Production Example of Composite Particles C20

In a 250-mL four-necked round-bottom flask equipped with an overhead stirrer, a condenser, and a thermocouple, 18.7 g of colloidal silica dispersion (silica solid content: 40% by mass, number-average particle size of silica: 30 nm (0.03 μm)), 125 mL of DI water, and 16.5 g (0.066 mol) of methacryloxypropyltrimethoxysilane were placed. The temperature was increased to 65° C., and the mixture was stirred at 120 rpm. Nitrogen gas was bubbled into the mixture for 30 minutes. After 3 hours, 0.16 g of 2,2′-azobis(isobutyronitrile), serving as a radical initiator, dissolved in 10 mL of ethanol was added, and the temperature was increased to 75° C.

The radical polymerization was allowed to proceed for 5 hours, followed by the addition of 3 mL of 1,1,1,3,3,3-hexamethyldisilazane to the mixture. The reaction was allowed to proceed for an additional 3 hours. The final mixture was filtered through a 170-mesh sieve to remove agglomerates. The dispersion was dried in a Pyrex (registered trademark) dish at 120° C. overnight to give composite particles C20.

The physical properties of the composite particles C1 to C20 produced as described above are presented in Table 1.

TABLE 1

| | Composite | | | | | | | | | |
|---|---|---|---|---|---|---|---|---|---|---|
| | particles | | Fine particles A | | | | | | | |
| Composite | Particle | Young's | True | | | | | | | |
| particles | size | modulus | density | Proportion | Proportion | Proportion | Pa + | Pb + | Pa/(Pa + | Pb/(Pa + |
| No. | (μm) | (GPa) | (g/cm³) | Pa | Pb | Pc | Pb + Pc | Pc | Pb + Pc) | Pb + Pc) |
| C1 | 0.12 | 15 | 1.35 | 0.40 | 0.00 | 0.60 | 1.00 | 0.60 | 0.40 | 0.00 |
| C2 | 0.12 | 15 | 1.35 | 0.30 | 0.50 | 0.20 | 1.00 | 0.70 | 0.30 | 0.50 |
| C3 | 0.12 | 30 | 1.35 | 0.65 | 0.00 | 0.35 | 1.00 | 0.35 | 0.65 | 0.00 |
| C4 | 0.12 | 8 | 1.35 | 0.30 | 0.00 | 0.70 | 1.00 | 0.70 | 0.30 | 0.00 |
| C5 | 0.12 | 9 | 1.35 | 0.00 | 0.80 | 0.20 | 1.00 | 1.00 | 0.00 | 0.80 |
| C6 | 0.12 | 31 | 1.35 | 0.70 | 0.30 | 0.00 | 1.00 | 0.30 | 0.70 | 0.30 |
| C7 | 0.30 | 15 | 1.35 | 0.40 | 0.00 | 0.60 | 1.00 | 0.60 | 0.40 | 0.00 |
| C8 | 0.06 | 15 | 1.35 | 0.40 | 0.00 | 0.60 | 1.00 | 0.60 | 0.40 | 0.00 |
| C9 | 0.30 | 15 | 1.35 | 0.40 | 0.00 | 0.60 | 1.00 | 0.60 | 0.40 | 0.00 |
| C10 | 0.05 | 15 | 1.35 | 0.40 | 0.00 | 0.60 | 1.00 | 0.60 | 0.40 | 0.00 |
| C11 | 0.12 | 15 | 1.35 | 0.40 | 0.00 | 0.60 | 1.00 | 0.60 | 0.40 | 0.00 |
| C12 | 0.12 | 15 | 1.55 | 0.40 | 0.00 | 0.60 | 1.00 | 0.60 | 0.40 | 0.00 |
| C13 | 0.12 | 15 | 1.65 | 0.40 | 0.00 | 0.60 | 1.00 | 0.60 | 0.40 | 0.00 |
| C14 | 0.33 | 15 | 1.35 | 0.40 | 0.00 | 0.60 | 1.00 | 0.60 | 0.40 | 0.00 |
| C15 | 0.02 | 15 | 1.35 | 0.40 | 0.00 | 0.60 | 1.00 | 0.60 | 0.40 | 0.00 |
| C16 | 0.12 | 15 | 1.35 | 0.40 | 0.00 | 0.60 | 1.00 | 0.60 | 0.40 | 0.00 |
| C17 | 0.12 | 32 | 1.35 | 0.80 | 0.00 | 0.20 | 1.00 | 0.20 | 0.80 | 0.20 |
| C18 | 0.12 | 12 | 1.35 | 0.00 | 1.00 | 0.00 | 1.00 | 1.00 | 0.00 | 1.00 |
| C19 | 0.12 | 15 | 1.35 | 0.40 | 0.00 | 0.60 | 1.00 | 1.00 | 0.00 | 1.00 |
| C20 | 0.12 | 40 | 1.50 | 0.00 | 0.00 | 0.00 | 0.00 | 0.00 | 0.00 | 0.00 |

| | Fine | | Fine particles B | | | | | |
|---|---|---|---|---|---|---|---|---|
| Composite | particles A | Surface | | Particle | Young's | | | |
| particles | Pc/(Pa + | treatment | Base | size | modulus | Embedding | | |
| No. | Pb + Pc) | agent | material | (μm) | (GPa) | ratio (%) | Sb/Sa | BD/AD |
| C1 | 0.60 | HMDS | Silica | 0.04 | 70 | 65 | 0.25 | 0.33 |
| C2 | 0.20 | HMDS | Silica | 0.04 | 70 | 65 | 0.25 | 0.33 |
| C3 | 0.35 | HMDS | Silica | 0.04 | 70 | 65 | 0.25 | 0.33 |
| C4 | 0.70 | HMDS | Silica | 0.04 | 70 | 65 | 0.25 | 0.33 |
| C5 | 0.20 | HMDS | Silica | 0.04 | 70 | 65 | 0.25 | 0.33 |
| C6 | 0.00 | HMDS | Silica | 0.04 | 70 | 65 | 0.25 | 0.33 |
| C7 | 0.60 | HMDS | Silica | 0.02 | 70 | 65 | 0.25 | 0.07 |
| C8 | 0.60 | HMDS | Silica | 0.04 | 70 | 65 | 0.25 | 0.67 |
| C9 | 0.60 | HMDS | Silica | 0.01 | 80 | 65 | 0.25 | 0.03 |
| C10 | 0.60 | HMDS | Silica | 0.04 | 70 | 65 | 0.48 | 0.80 |
| C11 | 0.60 | HMDS | Alumina | 0.04 | 80 | 65 | 0.25 | 0.33 |
| C12 | 0.60 | HMDS | Silica | 0.04 | 70 | 65 | 0.48 | 0.33 |
| C13 | 0.60 | HMDS | Silica | 0.04 | 70 | 65 | 0.26 | 0.33 |
| C14 | 0.60 | HMDS | Silica | 0.04 | 70 | 65 | 0.25 | 0.12 |
| C15 | 0.60 | HMDS | Silica | 0.01 | 70 | 20 | 0.25 | 0.50 |
| C16 | 0.60 | HMDS | Silica | 0.07 | 70 | 65 | 0.25 | 0.58 |
| C17 | 0.00 | HMDS | Silica | 0.04 | 70 | 65 | 0.55 | 0.33 |
| C18 | 0.00 | HMDS | Silica | 0.04 | 70 | 65 | 0.55 | 0.33 |
| C19 | 0.00 | HMDS | Polyester | 0.04 | 40 | 65 | 0.55 | 0.33 |
| C20 | 0.00 | HMDS | Silica | 0.04 | 70 | 65 | 0.85 | 0.33 |

### Production Example of Binder Resin A

Bisphenol A-propylene oxide adduct (2.2 mol adduct): 100.0 parts by mole
Terephthalic acid: 90.0 parts by mole

In a 5-L autoclave, 100 parts of the monomers constituting a polyester unit were mixed together with 500 ppm of titanium tetrabutoxide.

The above materials were weighed into a reaction vessel equipped with a condenser, a stirrer, a nitrogen inlet, and a thermocouple.

The air in the flask was replaced with nitrogen gas. The temperature was gradually increased under stirring. The mixture was reacted at 200° C. for 2 hours under stirring.

Furthermore, the pressure inside the reaction vessel was reduced to 8.3 kPa and maintained for 1 hour. The mixture was then cooled to 180° C. The pressure was brought to atmospheric pressure (first reaction step).
Trimellitic anhydride: 15.0 parts by mole

The above material was added thereto. The pressure in the reaction vessel was reduced to 8.3 kPa. The reaction was performed while the temperature was maintained at 160° C. The reaction time was adjusted so as to achieve a desired molecular weight. The reaction was stopped by reducing the temperature (second reaction step). The reaction mixture was ground to provide binder resin A. The binder resin A had a Tg of 63° C. and an acid value of 20.0 mgKOH/g. Other physical properties are presented in Table 2.

### Production Example of Binder Resin B

Binder resin B was produced in the same manner as in the production example of binder resin A, except that the types and amounts of the monomers added were changed as presented in Table 2, and the reaction time was adjusted to change the molecular weight and Tg. The physical properties of the resulting binder resin B are presented in Table 2.

TABLE 2

| | Formulation | | | | | | | |
|---|---|---|---|---|---|---|---|---|
| | BPA-PO | TPA | TMA | AA | Physical properties | | | |
| | (parts by | (parts by | (parts by | (parts by | Tg | Acid value | | |
| Binder resin | mole) | mole) | mole) | mole) | (° C.) | (mgKOH/g) | Mw | Mw/Mn |
| Binder resin A | 100 | 90 | 15 | — | 63 | 20 | 6500 | 3.4 |
| Binder resin B | 100 | 80 | 10 | 10 | 65 | 15 | 36000 | 7.6 |

BPA-PO propylene oxide adduct of bisphenol A (average amount added by mole: 2.2 mol)
TPA terephthalic acid
TMA trimellitic anhydride
AA adipic acid

### Production Example of Toner Particles 1

Polyester resin A: 70.0 parts
Polyester resin B: 30.0 parts
Fischer-Tropsch wax (peak temperature of maximum endothermic peak: 90° C., penetration: 3): 6.0 parts
Pigment Red 122:5.0 parts

The raw materials described in the above formulation were mixed using a Henschel mixer (FM-75, manufactured by Nippon Coke & Engineering Co., Ltd.) at a rotation speed of 20 s⁻¹ for a rotation time of 5 minutes. The mixture was then kneaded in a twin-screw kneader (PCM-30, manufactured by Ikegai Co., Ltd.) set at a temperature of 130° C. and a rotation speed of 300 rpm. The resulting kneaded product was cooled and coarsely crushed to a diameter of 1 mm or less with a hammer mill, resulting in a coarsely crushed product. The resulting coarsely crushed product was finely pulverized with a mechanical pulverizer (T-250, manufactured by Freund-Turbo Corporation). Further, classification was carried out using a rotary classifier (200TSP, manufactured by Hosokawa Micron Corporation) to provide toner particles 1. With regard to the operating condition of the rotary classifier (200TSP, manufactured by Hosokawa Micron Corporation), classification was performed at a rotation speed of a classification rotor of 50.0 s⁻¹. The resulting toner particles 1 had a weight-average particle size (D4) of 6.5 μm.

### Production Example of Toner 1

Toner particles 1:100 parts
Composite particles C1:5.0 parts

The above materials were mixed in a Henschel mixer model FM-10C (manufactured by Mitsui Miike Chemical Engineering Machinery, Co., Ltd.) at a rotation speed of 30 s⁻¹ for a rotation time of 10 minutes to provide toner 1.

### Production Examples of Toner Particles 2 to 7

Toner particles 2 to 7 were produced in the same manner as in the production example of toner particles 1, except that the types and amounts of the release agents were changed as presented in Table 3.

### Production Examples of Toners 2 to 29

Toners 2 to 29 were produced in the same manner as in the production example of toner 1, except that the types and amounts of the composite particles added were changed as presented in Table 3.

TABLE 3

| | | | | | | | | | | | | | | Parti- |
|---|---|---|---|---|---|---|---|---|---|---|---|---|---|---|
| | Toner | Binder | Amount | Binder | Amount | | Melting | | Amount | | Amount | | Amount | cle |
| Toner | particles | resin | added | resin | added | Release | point | Penetra- | added | Pig- | added | Composite | added | size |
| No. | No. | No. | (parts) | No. | (parts) | agent | ° C. | tion | (parts) | ment | (parts) | particles | (parts) | μm |
| Toner 1 | Toner | Binder | 70 | Binder | 30 | Fischer- | 90 | 3 | 6 | PR122 | 5 | C1 | 5 | 6.5 |
| | particles 1 | resin A | | resin B | | Tropsch | | | | | | | | |
| Toner 2 | Toner | Binder | 70 | Binder | 30 | Behenyl | 72 | 2 | 6 | PR122 | 5 | C1 | 5 | 6.5 |
| | particles 2 | resin A | | resin B | | behenate | | | | | | | | |
| Toner 3 | Toner | Binder | 70 | Binder | 30 | Fischer- | 105 | 1 | 6 | PR122 | 5 | C1 | 5 | 6.5 |
| | particles 3 | resin A | | resin B | | Tropsch | | | | | | | | |
| Toner 4 | Toner | Binder | 70 | Binder | 30 | Fischer- | 90 | 3 | 3 | PR122 | 5 | C1 | 5 | 6.5 |
| | particles 4 | resin A | | resin B | | Tropsch | | | | | | | | |
| Toner 5 | Toner | Binder | 70 | Binder | 30 | Fischer- | 90 | 3 | 15 | PR122 | 5 | C1 | 5 | 6.5 |
| | particles 5 | resin A | | resin B | | Tropsch | | | | | | | | |
| Toner 6 | Toner | Binder | 70 | Binder | 30 | Fischer- | 90 | 3 | 20 | PR122 | 5 | C2 | 5 | 6.5 |
| | particles 6 | resin A | | resin B | | Tropsch | | | | | | | | |
| Toner 7 | Toner | Binder | 70 | Binder | 30 | Fischer- | 90 | 3 | 6 | PR122 | 5 | C3 | 5 | 6.5 |
| | particles 1 | resin A | | resin B | | Tropsch | | | | | | | | |
| Toner 8 | Toner | Binder | 70 | Binder | 30 | Fischer- | 90 | 3 | 6 | PR122 | 5 | C4 | 5 | 6.5 |
| | particles 1 | resin A | | resin B | | Tropsch | | | | | | | | |
| Toner 9 | Toner | Binder | 70 | Binder | 30 | Fischer- | 90 | 3 | 6 | PR122 | 5 | C5 | 5 | 6.5 |
| | particles 1 | resin A | | resin B | | Tropsch | | | | | | | | |
| Toner 10 | Toner | Binder | 70 | Binder | 30 | Fischer- | 90 | 3 | 6 | PR122 | 5 | C6 | 5 | 6.5 |
| | particles 1 | resin A | | resin B | | Tropsch | | | | | | | | |
| Toner 11 | Toner | Binder | 70 | Binder | 30 | Fischer- | 90 | 3 | 6 | PR122 | 5 | C1 | 0.5 | 6.5 |
| | particles 1 | resin A | | resin B | | Tropsch | | | | | | | | |
| Toner 12 | Toner | Binder | 70 | Binder | 30 | Fischer- | 90 | 3 | 6 | PR122 | 5 | C1 | 20 | 6.5 |
| | particles 1 | resin A | | resin B | | Tropsch | | | | | | | | |
| Toner 13 | Toner | Binder | 70 | Binder | 30 | Fischer- | 90 | 3 | 6 | PR122 | 5 | C1 | 0.05 | 6.5 |
| | particles 1 | resin A | | resin B | | Tropsch | | | | | | | | |
| Toner 14 | Toner | Binder | 70 | Binder | 30 | Fischer- | 90 | 3 | 6 | PR122 | 5 | C1 | 21 | 6.5 |
| | particles 1 | resin A | | resin B | | Tropsch | | | | | | | | |
| Toner 15 | Toner | Binder | 70 | Binder | 30 | Fischer- | 90 | 3 | 6 | PR122 | 5 | C7 | 5 | 6.5 |
| | particles 1 | resin A | | resin B | | Tropsch | | | | | | | | |
| Toner 16 | Toner | Binder | 70 | Binder | 30 | Fischer- | 90 | 3 | 6 | PR122 | 5 | C8 | 5 | 6.5 |
| | particles 1 | resin A | | resin B | | Tropsch | | | | | | | | |
| Toner 17 | Toner | Binder | 70 | Binder | 30 | Fischer- | 90 | 3 | 6 | PR122 | 5 | C9 | 5 | 6.5 |
| | particles 1 | resin A | | resin B | | Tropsch | | | | | | | | |
| Toner 18 | Toner | Binder | 70 | Binder | 30 | Fischer- | 90 | 3 | 6 | PR122 | 5 | C10 | 5 | 6.5 |
| | particles 1 | resin A | | resin B | | Tropsch | | | | | | | | |
| Toner 19 | Toner | Binder | 70 | Binder | 30 | Fischer- | 90 | 3 | 6 | PR122 | 5 | C11 | 5 | 6.5 |
| | particles 1 | resin A | | resin B | | Tropsch | | | | | | | | |
| Toner 20 | Toner | Binder | 70 | Binder | 30 | Fischer- | 90 | 3 | 6 | PR122 | 5 | C12 | 5 | 6.5 |
| | particles 1 | resin A | | resin B | | Tropsch | | | | | | | | |
| Toner 21 | Toner | Binder | 70 | Binder | 30 | Fischer- | 90 | 3 | 6 | PR122 | 5 | C13 | 5 | 6.5 |
| | particles 1 | resin A | | resin B | | Tropsch | | | | | | | | |
| Toner 22 | Toner | Binder | 70 | Binder | 30 | Fischer- | 90 | 3 | 6 | PR122 | 5 | C14 | 5 | 6.5 |
| | particles 1 | resin A | | resin B | | Tropsch | | | | | | | | |
| Toner 23 | Toner | Binder | 70 | Binder | 30 | Fischer- | 90 | 3 | 6 | PR122 | 5 | C15 | 5 | 6.5 |
| | particles 1 | resin A | | resin B | | Tropsch | | | | | | | | |
| Toner 24 | Toner | Binder | 70 | Binder | 30 | Fischer- | 90 | 3 | 6 | PR122 | 5 | C16 | 5 | 6.5 |
| | particles 1 | resin A | | resin B | | Tropsch | | | | | | | | |
| Toner 25 | Toner | Binder | 70 | Binder | 30 | Fischer- | 90 | 3 | 6 | PR122 | 5 | C17 | 5 | 6.5 |
| | particles 1 | resin A | | resin B | | Tropsch | | | | | | | | |
| Toner 26 | Toner | Binder | 70 | Binder | 30 | Fischer- | 90 | 3 | 6 | PR122 | 5 | C18 | 5 | 6.5 |
| | particles 1 | resin A | | resin B | | Tropsch | | | | | | | | |
| Toner 27 | Toner | Binder | 70 | Binder | 30 | Fischer- | 90 | 3 | 6 | PR122 | 5 | C19 | 5 | 6.5 |
| | particles 1 | resin A | | resin B | | Tropsch | | | | | | | | |
| Toner 28 | Toner | Binder | 70 | Binder | 30 | Fischer- | 90 | 3 | 6 | PR122 | 5 | C20 | 5 | 6.5 |
| | particles 1 | resin A | | resin B | | Tropsch | | | | | | | | |
| Toner 29 | Toner | Binder | 70 | Binder | 30 | Fischer- | 77 | 6 | 6 | PR122 | 5 | C1 | 5 | 6.5 |
| | particles 7 | resin A | | resin B | | Tropsch | | | | | | | | |

### Production Example of Carrier 1

Magnetite 1 with a number-average particle size of 0.30 μm (magnetization intensity of 65 Am²/kg under a magnetic field of 1000/4π(kA/m))
Magnetite 2 with a number-average particle size of 0.50 μm (magnetization intensity of 65 Am²/kg under a magnetic field of 1000/4π(kA/m))

To 100 parts of each of the above materials, 4.0 parts of a silane compound (3-(2-aminoethylaminopropyl) trimethoxysilane) was added. The mixture was mixed and stirred at a high speed at 100° C. or higher in a vessel, thereby treating the fine particles of each material.
Phenol: 10% by mass
Formaldehyde solution: 6% by mass (40% by mass of formaldehyde, 10% by mass of methanol, and 50% by mass of water)
Magnetite 1 treated with the above silane compound: 58% by mass
Magnetite 2 treated with the above silane compound: 26% by mass

In a flask, 100 parts of the above materials, 5 parts of a 28% by mass aqueous ammonia solution, and 20 parts of water were placed. The mixture was heated to 85° C. over 30 minutes while being stirred and mixed. The temperature was held at 85° C. to perform a polymerization reaction for 3 hours, thereby curing the resulting phenolic resin. The cured phenolic resin was cooled to 30° C. Water was added thereto. The supernatant was removed. The precipitate was washed with water and then air-dried. The resulting product was dried at 60° C. under reduced pressure (5 mmHg or less) to provide magnetic material-dispersed spherical carrier 1. The 50% particle size (D50) of the carrier on a volume basis was 34.2 μm.

### Production Example of Developer 1

Toner 1 and carrier 1 were mixed in a V-type mixer (Model V-10, Tokuju Corporation) at a rotation speed of 0.5 s⁻¹ and a rotation time of 5 minutes in such a manner that the mixture contained 90 parts of carrier 1 and 10 parts of toner 1, thereby preparing two-component developer 1.

### Production Examples of Developers 2 to 29

Two-component developers 2 to 27 were produced in the same manner as in the production example of developer 1, except that the respective toners given in Table 4 were used.

### Examples 1 to 22 and Comparative Examples 1 to 7

The resulting developers were evaluated as described below.

### Evaluation of Inhibition of End Portion Soiling

The resulting two-component developers were subjected to the following evaluations. A modified full-color copier (trade name: imagePRESS C10000VP, manufactured by CANON KABUSHIKI KAISHA) was used as an image-forming apparatus. A two-component developer was placed in the developing unit of a magenta station. The copier was modified in such a manner that the process speed could be changed to 600 mm/sec.

The above apparatus was used to output 100,000 images in a normal temperature and normal humidity environment (23° C., 50% RH, hereafter also referred to as an “N/N environment”). The last 1,000 sheets were stacked and visually inspected for the presence of end portion soiling.

During image output, paper was passed under the same developing conditions and transfer conditions (however, there is no calibration) as those for the first sheet. The print rate of the output image was set to 30%. The developing bias was adjusted in such a manner that the initial image density was 1.55. As the paper for evaluation, A4-size plain paper (trade name: CF-C081, basis weight: 81.4 g/m², Canon Marketing Japan Inc.) for copying was used.
Evaluation Criteria
A: No end portion soiling is observed.
B: There is an image with suspected end portion soiling, but it remains at a level at which it cannot be determined whether there is clear soiling.
C: While very slight soling is observed, this is an acceptable level in an embodiment of the present disclosure.
D: Soiling is observed, and this is an unacceptable level in an embodiment of the present disclosure.

### Evaluation of Charging Stability

A modified full-color copier (trade name: imagePRESS C10000VP, manufactured by CANON KABUSHIKI KAISHA) was used as an image-forming apparatus. A two-component developer was placed in the developing unit of a magenta station. The copier was modified in such a manner that the process speed could be changed to 600 mm/sec.

The above apparatus was used to output 100,000 images in a high-temperature and high-humidity environment (30° C., 80% RH, hereinafter also referred to as an “H/H environment”). The density difference between the first sheet and the last sheet was evaluated.

During image output, paper was passed under the same developing conditions and transfer conditions (however, there is no calibration) as those for the first sheet. The print rate of the output image was set to 8%. The developing bias was adjusted in such a manner that the initial image density was 1.55. As the paper for evaluation, A4-size plain paper (trade name: CF-C081, basis weight: 81.4 g/m², Canon Marketing Japan Inc.) for copying was used.

### Evaluation Criteria

A: The density difference is 0.03 or less.
B: The density difference is 0.06 or less.
C: The density difference is 0.10 or less.
D: The density difference is more than 0.10.

### Evaluation of Low-Temperature Fixability

A modified full-color copier (trade name: imagePRESS C10000VP, manufactured by CANON KABUSHIKI KAISHA) was used as an image-forming apparatus. A two-component developer was placed in the developing unit of a magenta station. The copier was modified in such a manner that the process speed could be changed to 600 mm/sec. In addition, the copier was modified in such a manner that the fixing temperature was adjustable.

The above apparatus was used to output images in a low-temperature and low-humidity environment (20° C., 10% RH, hereinafter, also referred to as an “L/L environment”) while the fixing temperature is reduced. The temperature at which cold offset occurred was visually evaluated.

Each output image was a band image extending from a position 80 mm from the trailing end of the paper to the trailing end. The developing bias was adjusted in such a manner that the toner bearing amount of the unfixed image was 1.00 mg/cm². As the paper for evaluation, A4-size plain paper (trade name: CF-C081, basis weight: 81.4 g/m², Canon Marketing Japan Inc.) for copying was used.

### Evaluation Criteria

AA: The minimum fixing temperature is lower than 155° C.
A: The minimum fixing temperature is 160° C. or lower.
B: The minimum fixing temperature is 170° C. or lower.
C: The minimum fixing temperature is 180° C. or lower.
D: The minimum fixing temperature is higher than 180° C.

The results of the above evaluations are presented in Table 4.

TABLE 4

| | | | | | | Low-temperature fixability | |
|---|---|---|---|---|---|---|---|
| | | | End | Charging stability | | | Minimum |
| | | | portion | (HH/low duty) | | | fixing |
| | Developer | Toner | soiling | | Density | | temperature |
| | No. | No. | Evaluation | Evaluation | difference | Evaluation | (° C.) |
| Example 1 | Developer 1 | Toner 1 | A | A | 0.01 | A | 155 |
| Example 2 | Developer 2 | Toner 2 | A | A | 0.03 | AA | 150 |
| Example 3 | Developer 3 | Toner 3 | A | A | 0.03 | A | 155 |
| Example 4 | Developer 4 | Toner 4 | A | A | 0.01 | A | 155 |
| Example 5 | Developer 5 | Toner 5 | A | A | 0.02 | A | 155 |
| Example 6 | Developer 6 | Toner 6 | A | A | 0.02 | A | 155 |
| Example 7 | Developer 7 | Toner 7 | A | A | 0.03 | A | 155 |
| Example 8 | Developer 8 | Toner 8 | A | A | 0.03 | A | 155 |
| Example 9 | Developer 9 | Toner 9 | B | A | 0.03 | A | 160 |
| Example 10 | Developer 10 | Toner 10 | B | A | 0.03 | A | 160 |
| Example 11 | Developer 11 | Toner 11 | B | B | 0.04 | A | 160 |
| Example 12 | Developer 12 | Toner 12 | B | B | 0.04 | A | 160 |
| Example 13 | Developer 13 | Toner 13 | B | B | 0.05 | B | 165 |
| Example 14 | Developer 14 | Toner 14 | B | B | 0.05 | B | 165 |
| Example 15 | Developer 15 | Toner 15 | C | B | 0.06 | B | 165 |
| Example 16 | Developer 16 | Toner 16 | C | B | 0.06 | B | 165 |
| Example 17 | Developer 17 | Toner 17 | C | C | 0.07 | B | 170 |
| Example 18 | Developer 18 | Toner 18 | C | C | 0.08 | B | 170 |
| Example 19 | Developer 19 | Toner 19 | B | B | 0.04 | B | 165 |
| Example 20 | Developer 20 | Toner 20 | C | C | 0.09 | C | 175 |
| Example 21 | Developer 21 | Toner 21 | C | C | 0.09 | C | 175 |
| Example 22 | Developer 22 | Toner 22 | C | C | 0.10 | C | 180 |
| Comparative | Developer 23 | Toner 23 | D | D | 0.11 | D | 185 |
| Example 1 | | | | | | | |
| Comparative | Developer 24 | Toner 24 | D | D | 0.12 | C | 180 |
| Example 2 | | | | | | | |
| Comparative | Developer 25 | Toner 25 | D | C | 0.10 | D | 185 |
| Example 3 | | | | | | | |
| Comparative | Developer 26 | Toner 26 | D | D | 0.13 | C | 180 |
| Example 4 | | | | | | | |
| Comparative | Developer 27 | Toner 27 | D | D | 0.14 | D | 185 |
| Example 5 | | | | | | | |
| Comparative | Developer 28 | Toner 28 | D | D | 0.15 | D | 185 |
| Example 6 | | | | | | | |
| Comparative | Developer 29 | Toner 29 | D | D | 0.16 | D | 185 |
| Example 7 | | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-174001, filed Oct. 6, 2023, which is hereby incorporated by reference herein in its entirety.

What is claimed is:

1. A toner, comprising:
toner particles each containing:
a binder resin, and
a release agent; and
composite particles each present on a surface of each of the toner particles,
wherein the release agent has a penetration of 4 or less at 25° C.,
the composite particles include:
fine particles A each containing an organosilicon compound having a siloxane bond, the organosilicon compound serving as a binder component, and
fine particles B formed of inorganic fine particles,
each of the fine particles B is partially embedded at the surface of each of the fine particles A,
the following expressions (1) to (3) are satisfied:
$$Pa + Pb + Pc \geq 0.8 \qquad ( 1 )$$
$$Pb + Pc \geq 0.3 \qquad ( 2 )$$
$$Pa / ( Pa + Pb + Pc ) \leq 0.7 \qquad ( 3 )$$
where in the fine particles A, based on total silicon atoms contained in the organosilicon compound, Pa is a proportion of silicon atoms denoted by Si^{a} in a structure represented by the following unit (a), Pb is a proportion of silicon atoms denoted by Si^{b} in a structure represented by the following unit (b), and Pc is a proportion of silicon atoms denoted by Si^{c} in a structure represented by the following unit (c): 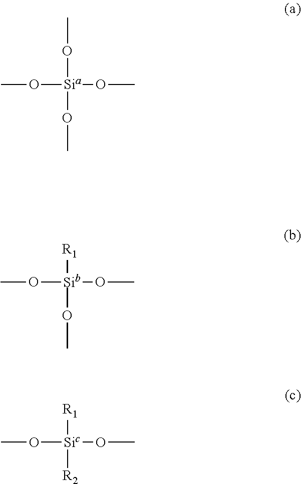
where R₁ and R₂ are each an alkyl group having 1 or more and 6 or less carbon atoms, the fine particles B have a number-average diameter of primary particles of 0.01 μm or more and 0.06 μm or less, and
in the composite particles, an average value of embedding ratios of the fine particles B to the fine particles A is 30% or more and 90% or less, each of the embedding ratios being represented by the following expression:
Each embedding ratio of each fine particle B to each fine particle A (%)=(a depth of each fine particle B embedded in each fine particle A/a diameter of each fine particle B)×100.

2. The toner according to claim 1, wherein the composite particles have a number-average diameter of primary particles of 0.03 μm or more and 0.30 μm or less.

3. The toner according to claim 1, wherein the fine particles A have a true specific gravity of 1.00 g/cm³ or more and 1.60 g/cm³ or less.

4. The toner according to claim 1, wherein, in an electron image obtained by photographing sections of the fine particles A with a transmission electron microscope, Sa is an area of a section X of one particle of the fine particles A photographed, Sb is a total area of the fine particles B that are entirely contained in the section X and that are present in an unexposed state, and an average value of Sb/Sa for 100 particles of the fine particles A is 0 or more and 0.50 or less.

5. The toner according to claim 1, wherein the fine particles B are fine silica particles or fine alumina particles.

6. The toner according to claim 1, wherein AD is a number-average diameter of primary particles of the fine particles A, BD is the number-average diameter of the primary particles of the fine particles B, and a BD/AD ratio is 0.05 or more and 0.70 or less.

7. The toner according to claim 1, wherein the composite particles have a Young's modulus of 10 GPa or more and 30 GPa or less.

8. The toner according to claim 1, wherein the proportions Pa, Pb, and Pc in the fine particles A satisfy the following expressions (I), (II), and (III):
$$0.3 \leq Pa / ( Pa + Pb + Pc ) \leq 0.7 \qquad ( I )$$
$$0 \leq Pb / ( Pa + Pb + Pc ) \leq 0.5 \qquad ( II )$$
$$0.2 \leq Pc / ( Pa + Pb + Pc ) \leq 0.7 \qquad ( III )$$

9. The toner according to claim 1, wherein an amount of the release agent contained is 3.0 parts by mass or more and 15.0 parts by mass or less based on 100 parts by mass of the binder resin.

10. The toner according to claim 1, wherein X is an amount of the composite particles contained, Y is an amount of the release agent contained, and a ratio X/Y is 0.08 or more and 3.33 or less.

11. The toner according to claim 1, wherein the release agent is a hydrocarbon wax.

12. The toner according to claim 1, wherein the release agent is an ester wax.

13. The toner according to claim 1, wherein an amount of the composite particles contained in the toner is 0.5 parts by mass or more and 20.0 parts by mass or less based on 100 parts by mass of the toner particles.
